(19) United States
(12) Patent Application Publication
(10) Pub. No.: US 2025/0380276 A1
(43) Pub. Date: Dec. 11, 2025

(54) TECHNIQUES FOR INDICATING MISSING CODING RATES IN WIRELESS COMMUNICATIONS

(71) Applicant: QUALCOMM Incorporated, San Diego, CA (US)

(72) Inventors: Mostafa KHOSHNEVISAN, San Diego, CA (US); Sitaramanjaneyulu KANAMARLAPUDI, San Diego, CA (US); Jing SUN, San Diego, CA (US); Gabi SARKIS, San Diego, CA (US); Kianoush HOSSEINI, San Diego, CA (US); Jing JIANG, San Diego, CA (US); Junyi LI, Greentown, PA (US)

(21) Appl. No.: 18/735,992

(22) Filed: Jun. 6, 2024

(51) Int. Cl. H04W 72/232; H04L 1/00

(52) U.S. Cl. CPC H04W 72/232; H04L 1/0009

(57) ABSTRACT

Methods, systems, and devices for wireless communications are described for an indication by a user equipment (UE) that a coding rate for a downlink transmission to the UE is unknown. A UE may receive a second control information message that indicates a set of wireless resources for a downlink transmission to the UE, and that indicates that a coding rate for the downlink transmission is provided in a prior first control information message, where the first control information message has not been successfully received and decoded at the UE. The UE may transmit a feedback message associated with the second control information message that includes an indication that the coding rate associated with the downlink transmission is unknown at the UE.

### FIELD OF TECHNOLOGY

The following relates to wireless communications, including techniques for indicating missing coding rates in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a second control information message that indicates a set of wireless resources for a downlink transmission to the UE, where the second control information message indicates that a coding rate for the downlink transmission is provided in a first control information message and transmitting a feedback message associated with the second control information message that includes an indication that the coding rate associated with the downlink transmission is unknown at the UE based on the first control information message being unsuccessfully received at the UE.

A UE for wireless communications is described. The UE may include one or more memories storing processor executable code, and one or more processors coupled with the one or more memories. The one or more processors may individually or collectively be operable to execute the code to cause the UE to receive a second control information message that indicates a set of wireless resources for a downlink transmission to the UE, where the second control information message indicates that a coding rate for the downlink transmission is provided in a first control information message and transmit a feedback message associated with the second control information message that includes an indication that the coding rate associated with the downlink transmission is unknown at the UE based on the first control information message being unsuccessfully received at the UE.

Another UE for wireless communications is described. The UE may include means for receiving a second control information message that indicates a set of wireless resources for a downlink transmission to the UE, where the second control information message indicates that a coding rate for the downlink transmission is provided in a first control information message and means for transmitting a feedback message associated with the second control information message that includes an indication that the coding rate associated with the downlink transmission is unknown at the UE based on the first control information message being unsuccessfully received at the UE.

A non-transitory computer-readable medium storing code for wireless communications is described. The code may include instructions executable by one or more processors to receive a second control information message that indicates a set of wireless resources for a downlink transmission to the UE, where the second control information message indicates that a coding rate for the downlink transmission is provided in a first control information message and transmit a feedback message associated with the second control information message that includes an indication that the coding rate associated with the downlink transmission is unknown at the UE based on the first control information message being unsuccessfully received at the UE.

Some examples of the method, UEs, and non-transitory computer-readable medium described herein may further include operations, features, means, or instructions for receiving, subsequent to transmitting the feedback message, a third control information message that indicates the coding rate for the downlink transmission.

In some examples of the method, UEs, and non-transitory computer-readable medium described herein, the feedback message indicates that a transport block size associated with the downlink transmission is unknown at the UE.

In some examples of the method, UEs, and non-transitory computer-readable medium described herein, the feedback message indicates that a reserved modulation and coding scheme is indicated for the downlink transmission, and that a new data indicator for a feedback identifier associated with the downlink transmission is toggled in the second control information message.

Some examples of the method, UEs, and non-transitory computer-readable medium described herein may further include operations, features, means, or instructions for transmitting an indication of whether soft-coded bits associated with the downlink transmission are stored at the UE.

In some examples of the method, UEs, and non-transitory computer-readable medium described herein, the indication of whether soft-coded bits associated with the downlink transmission are stored at the UE is provided with a capability indication provided by the UE, or is included with the feedback message associated with the second control information message.

In some examples of the method, UEs, and non-transitory computer-readable medium described herein, the UE indicates that soft-coded bits associated with a first instance of the downlink transmission are stored at the UE and the method, apparatuses, and non-transitory computer-readable medium may include further operations, features, means, or instructions for receiving a second instance of the downlink transmission associated with a third control information message, where the third control information message indicates that the second instance of the downlink transmission has a different redundancy version than the first instance of the downlink transmission, combining the soft-coded bits associated with the first instance of the downlink transmission with soft-coded bits associated with the second instance of the downlink transmission, and decoding the combined soft-coded bits to obtain information provided in the downlink transmission.

In some examples of the method, UEs, and non-transitory computer-readable medium described herein, the indication that the coding rate associated with the downlink transmission is unknown at the UE is included if the coding rate is unknown to the UE for at least one downlink transmission associated with the feedback message, and is provided in addition to a set of acknowledgment or negative-acknowledgment bits included in the feedback message.

In some examples of the method, UEs, and non-transitory computer-readable medium described herein, the feedback message includes a single bit to indicate whether the coding rate associated with the at least one downlink transmission is known or unknown at the UE.

In some examples of the method, UEs, and non-transitory computer-readable medium described herein, the feedback message includes two bits in addition to the set of acknowledgment or negative-acknowledgment bits, and where a first bit of the two bits indicates that the second control information message was successfully received and whether or not the coding rate associated with the at least one downlink transmission is unknown, and a second bit of the two bits indicates whether or not one or more control information messages have been received.

In some examples of the method, UEs, and non-transitory computer-readable medium described herein, the indication that the coding rate associated with the downlink transmission is unknown at the UE is provided separately for each of a set of multiple downlink transmissions associated with the feedback message.

In some examples of the method, UEs, and non-transitory computer-readable medium described herein, the feedback message includes a three-state feedback indication associated with the downlink transmission, and where a third state of the three-state feedback indication indicates the coding rate associated with the downlink transmission is unknown at the UE.

In some examples of the method, UEs, and non-transitory computer-readable medium described herein, the feedback message includes a four-state feedback indication associated with the downlink transmission, and where a third state indicates the second control information message was unsuccessfully received at the UE, and a fourth state of the four-state feedback indication indicates the coding rate associated with the downlink transmission is unknown at the UE.

In some examples of the method, UEs, and non-transitory computer-readable medium described herein, the feedback message indicates whether the coding rate associated with one or more dynamically scheduled downlink transmissions is known or unknown at the UE, and the indication does not apply to one or more semi-persistently scheduled downlink transmissions associated with the feedback message.

Some examples of the method, UEs, and non-transitory computer-readable medium described herein may further include operations, features, means, or instructions for receiving configuration information that indicates whether the feedback message is to include the indication that the coding rate associated with the downlink transmission is unknown at the UE.

In some examples of the method, UEs, and non-transitory computer-readable medium described herein, the configuration information is provided per cell-group for all carriers of each indicated cell group, per carrier, or per subset of feedback identifiers in a carrier.

Some examples of the method, UEs, and non-transitory computer-readable medium described herein may further include operations, features, means, or instructions for transmitting capability signaling to a network entity that indicates the UE supports transmission of feedback messages that indicate whether the coding rate associated with one or more downlink transmissions is unknown at the UE.

A method for wireless communications by a network entity is described. The method may include outputting a first control information message that indicates a coding rate for a downlink transmission and a first set of wireless resources for a first instance of the downlink transmission to a UE, outputting the first instance of the downlink transmission, outputting a second control information message that indicates a second set of wireless resources for a second instance of the downlink transmission, where the second control information message indicates that the coding rate for the second instance of the downlink transmission is provided in the first control information message, outputting the second instance of the downlink transmission, and obtaining, from the UE, a feedback message associated with the second control information message that includes an indication the coding rate associated with the downlink transmission is unknown at the UE.

A network entity for wireless communications is described. The network entity may include one or more memories storing processor executable code, and one or more processors coupled with the one or more memories. The one or more processors may individually or collectively be operable to execute the code to cause the network entity to output a first control information message that indicates a coding rate for a downlink transmission and a first set of wireless resources for a first instance of the downlink transmission to a UE, output the first instance of the downlink transmission, output a second control information message that indicates a second set of wireless resources for a second instance of the downlink transmission, where the second control information message indicates that the coding rate for the second instance of the downlink transmission is provided in the first control information message, output the second instance of the downlink transmission, and obtain, from the UE, a feedback message associated with the second control information message that includes an indication the coding rate associated with the downlink transmission is unknown at the UE.

Another network entity for wireless communications is described. The network entity may include means for outputting a first control information message that indicates a coding rate for a downlink transmission and a first set of wireless resources for a first instance of the downlink transmission to a UE, means for outputting the first instance of the downlink transmission, means for outputting a second control information message that indicates a second set of wireless resources for a second instance of the downlink transmission, where the second control information message indicates that the coding rate for the second instance of the downlink transmission is provided in the first control information message, means for outputting the second instance of the downlink transmission, and means for obtaining, from the UE, a feedback message associated with the second control information message that includes an indication the coding rate associated with the downlink transmission is unknown at the UE.

A non-transitory computer-readable medium storing code for wireless communications is described. The code may include instructions executable by one or more processors to output a first control information message that indicates a coding rate for a downlink transmission and a first set of wireless resources for a first instance of the downlink transmission to a UE, output the first instance of the downlink transmission, output a second control information message that indicates a second set of wireless resources for a second instance of the downlink transmission, where the second control information message indicates that the coding rate for the second instance of the downlink transmission is provided in the first control information message, output the second instance of the downlink transmission, and obtain, from the UE, a feedback message associated with the second control information message that includes an indication the coding rate associated with the downlink transmission is unknown at the UE.

Some examples of the method, network entities, and non-transitory computer-readable medium described herein may further include operations, features, means, or instructions for outputting, subsequent to obtaining the feedback message, a third control information message that indicates the coding rate for the downlink transmission.

In some examples of the method, network entities, and non-transitory computer-readable medium described herein, the feedback message indicates that a transport block size associated with the downlink transmission is unknown at the UE.

In some examples of the method, network entities, and non-transitory computer-readable medium described herein, the feedback message indicates that a reserved modulation and coding scheme is indicated for the downlink transmission, and that a new data indicator for a feedback identifier associated with the downlink transmission is toggled in the second control information message.

Some examples of the method, network entities, and non-transitory computer-readable medium described herein may further include operations, features, means, or instructions for obtaining an indication of whether soft-coded bits associated with the downlink transmission are stored at the UE.

In some examples of the method, network entities, and non-transitory computer-readable medium described herein, the indication of whether soft-coded bits associated with the downlink transmission are stored at the UE is provided with a capability indication provided by the UE, or is included with the feedback message associated with the second control information message.

Some examples of the method, network entities, and non-transitory computer-readable medium described herein may further include operations, features, means, or instructions for outputting a second instance of the downlink transmission associated with a third control information message, where the third control information message indicates that the second instance of the downlink transmission has a different redundancy version than the first instance of the downlink transmission.

In some examples of the method, network entities, and non-transitory computer-readable medium described herein, the indication that the coding rate associated with the downlink transmission is unknown at the UE is applied to at least one downlink transmission associated with the feedback message, and is provided in addition to a set of acknowledgment or negative-acknowledgment bits included in the feedback message.

In some examples of the method, network entities, and non-transitory computer-readable medium described herein, the feedback message includes a single bit to indicate whether the coding rate associated with the at least one downlink transmission is known or unknown at the UE.

In some examples of the method, network entities, and non-transitory computer-readable medium described herein, the feedback message includes two bits in addition to the set of acknowledgment or negative-acknowledgment bits, and where a first bit of the two bits indicates that the second control information message was successfully received and that the coding rate associated with the at least one downlink transmission is unknown, and a second bit of the two bits indicates whether or not one or more control information messages have been received.

In some examples of the method, network entities, and non-transitory computer-readable medium described herein, the indication that the coding rate associated with the downlink transmission is unknown at the UE is provided separately for each of a set of multiple downlink transmissions associated with the feedback message.

In some examples of the method, network entities, and non-transitory computer-readable medium described herein, the feedback message includes a three-state feedback indication associated with the downlink transmission, and where a third state of the three-state feedback indication indicates the coding rate associated with the downlink transmission is unknown at the UE.

In some examples of the method, network entities, and non-transitory computer-readable medium described herein, the feedback message includes a four-state feedback indication associated with the downlink transmission, and where a third state indicates the second control information message was unsuccessfully received at the UE, and a fourth state of the four-state feedback indication indicates the coding rate associated with the downlink transmission is unknown at the UE.

In some examples of the method, network entities, and non-transitory computer-readable medium described herein, the feedback message indicates whether the coding rate associated with one or more dynamically scheduled downlink transmissions is known or unknown at the UE, and the indication does not apply to one or more semi-persistently scheduled downlink transmissions associated with the feedback message.

Some examples of the method, network entities, and non-transitory computer-readable medium described herein may further include operations, features, means, or instructions for outputting configuration information for the UE that indicates whether the feedback message is to include the indication that the coding rate associated with the downlink transmission is unknown at the UE.

In some examples of the method, network entities, and non-transitory computer-readable medium described herein, the configuration information is provided per cell-group for all carriers of each indicated cell group, per carrier, or per subset of feedback identifiers in a carrier.

Some examples of the method, network entities, and non-transitory computer-readable medium described herein may further include operations, features, means, or instructions for obtaining capability signaling from the UE that indicates the UE supports transmission of feedback messages that indicate whether the coding rate associated with one or more downlink transmissions is unknown at the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for indicating missing coding rates in wireless communications in accordance with one or more aspects of the present disclosure.

FIG. 2 shows an example of a wireless communications system that supports techniques for indicating missing coding rates in wireless communications in accordance with one or more aspects of the present disclosure.

FIG. 3 shows an example of a timing diagram that supports techniques for indicating missing coding rates in wireless communications in accordance with one or more aspects of the present disclosure.

FIG. 4 shows an example of a timing diagram that supports techniques for indicating missing coding rates in wireless communications in accordance with one or more aspects of the present disclosure.

FIG. 5 shows an example of a process flow that supports techniques for indicating missing coding rates in wireless communications in accordance with one or more aspects of the present disclosure.

FIGS. 6 and 7 show block diagrams of devices that support techniques for indicating missing coding rates in wireless communications in accordance with one or more aspects of the present disclosure.

FIG. 8 shows a block diagram of a communications manager that supports techniques for indicating missing coding rates in wireless communications in accordance with one or more aspects of the present disclosure.

FIG. 9 shows a diagram of a system including a device that supports techniques for indicating missing coding rates in wireless communications in accordance with one or more aspects of the present disclosure.

FIGS. 10 and 11 show block diagrams of devices that support techniques for indicating missing coding rates in wireless communications in accordance with one or more aspects of the present disclosure.

FIG. 12 shows a block diagram of a communications manager that supports techniques for indicating missing coding rates in wireless communications in accordance with one or more aspects of the present disclosure.

FIG. 13 shows a diagram of a system including a device that supports techniques for indicating missing coding rates in wireless communications in accordance with one or more aspects of the present disclosure.

FIGS. 14 through 17 show flowcharts illustrating methods that support techniques for indicating missing coding rates in wireless communications in accordance with one or more aspects of the present disclosure.

### DETAILED DESCRIPTION

In some wireless communications systems, initial transmissions of a communication between a network entity and a user equipment (UE) (e.g., a physical downlink shared channel (PDSCH) communication) may be scheduled using downlink control information (DCI) (e.g., a first DCI) that is transmitted in a control channel communication (e.g., a physical downlink control channel (PDCCH) communication), where the DCI may indicate wireless resources for the transmission and an indication of an modulation and coding scheme (MCS) index value from an MCS index table. The index value from the MCS index table may indicate, for example, a modulation order, target code rate, and spectral efficiency of the associated downlink transmission. In some cases, the MCS index table may also include one or more MCS index values that have a ‘reserved’ target code rate and spectral efficiency. In such cases, the network entity may indicate one of the reserved MCS index values in a second DCI for retransmission of the communication, which may allow the retransmission to be transmitted using different resource allocation parameters than the initial transmission, thereby providing enhanced flexibility at the network scheduler by allowing the different instances of the communication to have different resource allocation parameters. However, if the UE fails to successfully receive the first DCI, the coding rate for the retransmission may be unknown at the UE, even though the UE successfully received the second DCI. In such situations, the UE may be unable to decode the retransmission because it cannot determine a transport block size (TBS) of the communication, which is based on the coding rate and other parameters associated with a resource allocation. Thus, efficient techniques for indication that a UE is unaware of a coding rate for a communication (e.g., a PDSCH communication) may help to enhance network efficiency and scheduling flexibility, reduce latency, and enhance user experience.

In accordance with various aspects, a UE may transmit feedback (e.g., hybrid automatic repeat request (HARQ) feedback) that indicates whether a coding rate for a downlink communication (e.g., a PDSCH retransmission or transport block (TB)) is known or unknown to the UE. In some aspects, the feedback message may be modified from traditional feedback messages (e.g., traditional HARQ feedback messages) to include an additional bit in addition to acknowledgment/negative-acknowledgment (ACK/NACK) bits, and the additional bit may indicate whether or not the coding rate for one or more transmissions (e.g., one or more PDSCH communications) associated with the feedback message is known or unknown to the UE. In some aspects, the feedback message may include two additional bits, where a first additional bit indicates whether the DCI associated with the retransmission is successfully received and a second additional bit indicates whether the coding rate is known or unknown. In still other aspects, each reported ACK/NACK may be a 3-state or 4-state feedback that provides the indication per PDSCH/TB, where the additional states indicate one or more of whether the DCI associated with the retransmission is successfully received or whether the coding rate is known or unknown. In some aspects, the indication of whether a coding rate for a retransmission is known or unknown may apply only to dynamically scheduled PDSCHs/TBs, and does not apply to semi-persistent scheduling (SPS) PDSCHs/TBs, because the coding rate and TBS for SPS communications may be determined based on an SPS configuration and not an indicated MCS. Further, in some aspects, the UE may provide capability signaling of whether this type of feedback is supported, and may be configured to enable or disable this type of feedback.

Additionally, or alternatively, when a coding rate is missing for a downlink communication (e.g., a PDSCH communication), a UE may report if it has stored soft coded bits (e.g., log likelihood ratios) for a TB with a missing coding rate. A network entity may use this information to determine a suitable redundancy version (RV) for one or more subsequent retransmissions. For example, if the coding rate is missing but UE has stored LLRs, the network entity may indicate an explicit MCS and a different RV compared to the one indicated in the most recent retransmission of the TB; and if the coding rate is missing and the UE has not stored LLRs, the network entity may indicate explicit MCS and also an initial RV indication (e.g., RVO) because soft combining is not possible. In some cases, the soft-combining indication may be semi-static as part of UE capability signaling, or dynamic as part of the feedback payload for each instance that the UE indicates the coding rate is missing.

While various examples discussed herein reference that a UE is unaware of a coding rate for a communication, such a missing coding rate may equivalently be referred to as a UE having an unknown TBS for a communication (e.g., a TBS cannot be determined for one or more PDSCHs or TBs). For example, TBS may be determined based on a target code rate indicated in a MCS index table, and if a UE is unaware of a coding rate for a communication, the TBS may also be unknown. Further, a missing coding rate also may be equivalently referred to as a UE having identified a reserved MCS indication in a DCI for an initial transmission of a PDSCH communication or TB from the perspective of the UE (e.g., based on a toggled new data indicator (NDI) for a feedback process indicated in the DCI).

Aspects of the disclosure are initially described in the context of wireless communications systems. Aspects of the disclosure are further illustrated by and described with reference to timing diagrams, a process flow, apparatus diagrams, system diagrams, and flowcharts that relate to techniques for indicating missing coding rates in wireless communications.

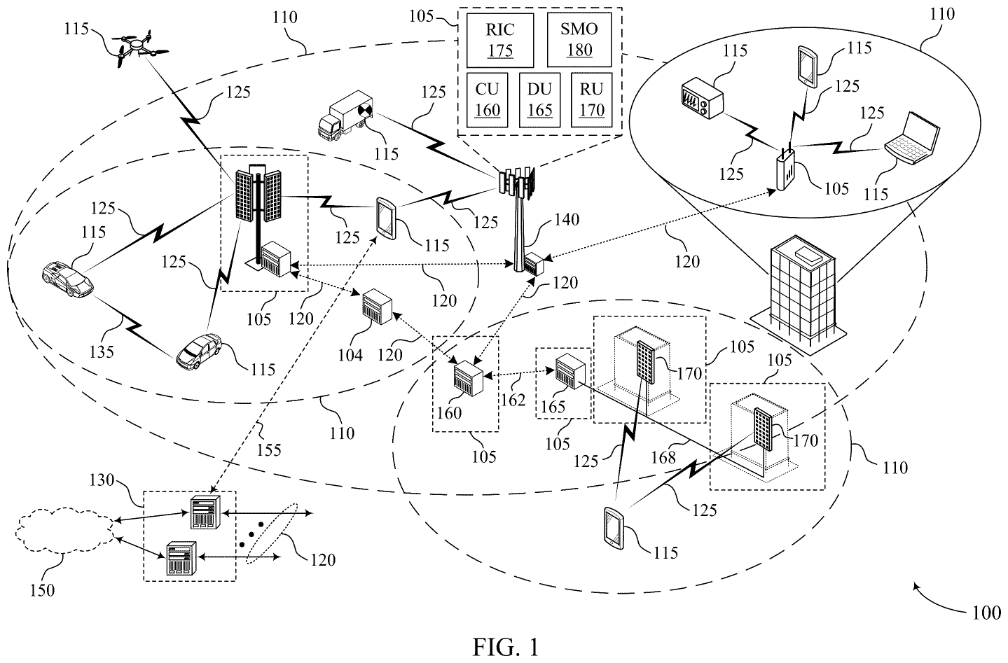

FIG. 1 shows an example of a wireless communications system 100 that supports techniques for indicating missing coding rates in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless

communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, a network entity 105 may transmit two or more instances of a transmission to a UE 115, including an initial instance of the transmission and one or more additional instances of retransmissions of the transmission. In some cases, the initial instance of the transmission may be scheduled by first control information (e.g., a first DCI) that provides an explicit indication of various coding parameters for the transmission (e.g., an indication of an MCS index from an MCS table that maps to explicit coding parameters), such as a coding rate or TBS, and one or more subsequent instances of the transmission may be scheduled by second control information (e.g., a second DCI) that provides an implicit indication that the coding parameters were provided in the first control information (e.g., an indication of an MCS index from an MCS table that maps to a ‘reserved’ value of coding parameters). In accordance with various techniques discussed herein, a UE 115 may provide an indication that a coding rate for a downlink transmission to the UE 115 is unknown. In some cases, a UE 115 may receive a second control information message from a network entity 105 that indicates a set of wireless resources for a downlink transmission to the UE 115, and that indicates that a coding rate for the downlink transmission is provided in a prior first control information message, where the first control information message has not been successfully received and decoded at the UE 115. The UE 115 may transmit a feedback message associated with the second control information message that includes an indication that the coding rate associated with the downlink transmission is unknown at the UE 115.

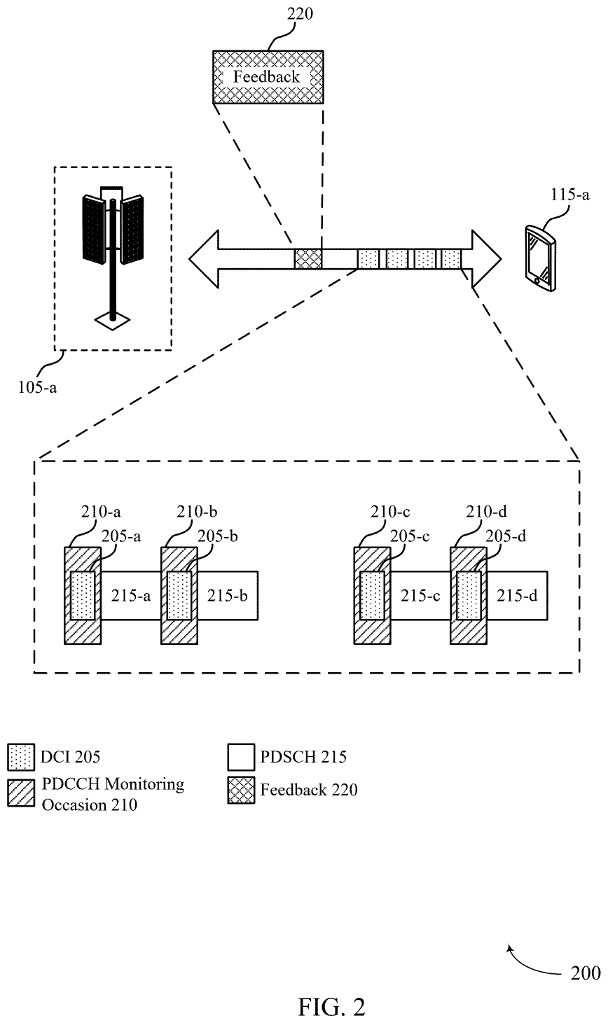

FIG. 2 shows an example of a wireless communications system 200 that supports techniques for indicating missing coding rates in wireless communications in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In this example, the network entity 105-a may transmit one or more DCI 205 transmissions in associated PDCCH monitoring occasions 210. The DCI 205 transmissions may indicate resource allocations and transmission parameters for associated PDSCH 215 transmissions. For example, a first DCI 205-a in a first PDCCH monitoring occasion 210-a may indicate resources for a first PDSCH 215-a transmission, a second DCI 205-b in a second PDCCH monitoring occasion 210-b may indicate resources for a second PDSCH 215-b transmission, a third DCI 205-c in a third PDCCH monitoring occasion 210-c may indicate resources for a third PDSCH 215-c transmission, and a fourth DCI 205-d in a fourth PDCCH monitoring occasion 210-d may indicate resources for a fourth PDSCH 215-d transmission. The UE 115-a may provide feedback 220 that indicates whether each PDSCH 215 is successfully or unsuccessfully received at the UE 115-a. For example, HARQ feedback may provide an ACK/NACK indication for PDSCHs 215 or TBs.

In some wireless communications systems, such as the wireless communications system 200, wireless devices (e.g., UE 115-a) may support retransmissions of one or more communications (e.g., PDSCHs 215), such as when an acknowledgment of receipt of the communication is not provided (e.g., a NACK indication in feedback 220, or feedback for a particular HARQ ID is not provided) or in accordance with coverage enhancement techniques in which multiple instances of a communication are transmitted. As discussed herein, in some cases a TBS for a transmission may be determined based on resource allocation indicated in the DCI (e.g., frequency domain resource allocation (FDRA), time division resource allocation (TDRA), a number of layers) excluding demodulation reference signal (DMRS) resource elements (REs), as well as a modulation order and code rate (also referred to interchangeably as coding rate) indicated in the DCI. For example, the modulation order and code rate may be indicated in an MCS field in DCI that provides an MCS index value to an MCS table that maps modulation order, code rate, and spectral efficiency to different index values. In some cases, the MCS table may also include one or more index values that are mapped to ‘reserved’ code rates, and a reserved MCS may be used for retransmissions of the same TB. Thus, a reserved MCS only indicates modulation order for retransmission, but not the coding rate. When reserved MCS is indicated, the UE 115-a has to already know the TBS from an earlier transmission of the same TB. Otherwise, UE 115-a cannot decode (it can only demodulate and save LLRs for future soft combining). Such an indication of a reserved MCS may provide enhanced flexibility in resource allocation (e.g., the network entity 105-a does not have to ensure the TDRA/FDRA/MCS/number of layers result in the same TBS as the initial transmission).

As discussed herein, if a DCI 205 scheduling initial transmission for a PDSCH 215 or TB is missed (e.g., the first DCI 205-a scheduling first PDSCH 215-a is not successfully decoded from the first PDCCH monitoring occasion 210-a at the UE 115-a), and the network entity 105-a indicates a reserved MCS in a subsequent DCI 205 (e.g., second DCI 205-b) for scheduling retransmissions, the UE 115-a is not able to decode retransmitted PDSCH 215 (e.g., second PDSCH 215-b), because the TBS of the transmission unknown. In such situations, from the point of view of the UE 115-a, the second DCI 205-b schedules an initial transmission of a TB, but the UE 115-a cannot determine the TBS. In some cases, the UE 115-a may still perform demodulation (e.g., calculate and save LLRs) for possible soft combining in case that future retransmission DCIs (e.g., third DCI 205-c and/or fourth DCI 205-d) indicate an explicit MCS for the transmission (e.g., associated with a HARQ ID of the transmission).

In accordance with various techniques discussed herein, the UE 115-a may transmit feedback 220 (e.g., HARQ feedback) that indicates whether a coding rate for a downlink communication (e.g., a PDSCH 215 retransmission or TB) is known or unknown to the UE 115-a. In some aspects, the feedback 220 may include a message that may be modified from traditional feedback messages (e.g., traditional HARQ feedback messages) to include an additional bit in addition to ACK/NACK bits, and the additional bit may indicate whether or not the coding rate for one or more transmissions (e.g., one or more PDSCH 215 communications) associated with the feedback 220 is known or unknown to the UE 115-a. In some aspects, the feedback 220 may include two additional bits, where a first additional bit indicates whether the DCI 205 associated with the retransmission is successfully received and a second additional bit indicates whether the coding rate is known or unknown. In some aspects, feedback 220 may include a 3-state or 4-state feedback that provides the indication per PDSCH 215 or TB, where the additional states indicate one or more of whether the DCI 205 associated with the retransmission is successfully received or whether the coding rate is known or unknown. In some aspects, the indication that a coding rate for a retransmission is known or unknown may apply only to dynamically scheduled PDSCHs 215 or TBs, and does not apply to SPS PDSCHs 215 or TBs, because the coding rate and TBS for SPS communications may be determined based on an SPS configuration and not an indicated MCS that is provided in DCI 205. Further, in some aspects, the UE 115-a may provide capability signaling of whether this type of feedback is supported, and may be configured to enable or disable this type of feedback.

Additionally, or alternatively, when a coding rate is missing for a downlink communication (e.g., a PDSCH 215 communication), a UE 115-a may report if it has stored soft coded bits (e.g., log likelihood ratios (LLRs)) for a TB with a missing code rate. The network entity 105-a may use this information to determine a suitable RV for one or more subsequent retransmissions. For example, if the code rate is missing but UE 115-a has stored LLRs, the network entity 105-a may indicate an explicit MCS and a different RV compared to the one indicated in the most recent retransmission; and if the code rate is missing and the UE 115-a has not stored LLRs, the network entity 105-a may indicate explicit MCS and also an initial RV indication (e.g., RVO) because soft combining is not possible. In some cases, the soft-combining indication may be semi-static as part of UE 115-a capability signaling, or dynamic as part of the feedback payload for each instance that the UE 115-a indicates the coding rate is missing.

While various examples discussed herein reference that the UE 115-a is unaware of a coding rate for a communication, such a missing coding rate may equivalently be referred to as a UE 115-a having an unknown TBS for a communication (e.g., a TBS cannot be determined for one or more PDSCHs 215 or TBs). For example, TBS may be determined based on a target code rate indicated in a MCS index table, and if the UE 115-a is unaware of a coding rate for a communication, the TBS may also be unknown. Further, a missing coding rate also may be equivalently referred to as the UE 115-a having identified a reserved MCS indication in a DCI 205 for an initial transmission of a PDSCH 215 communication or TB from the perspective of the UE 115-a (e.g., based on a toggled NDI for a feedback process indicated in the DCI).

In some aspects, feedback 220 may include an indication of an unknown coding rate in the HARQ-ACK codebook for each PDSCH 215 or TB. In some cases, a 3-state feedback per PDSCH 215 may be provided, where the third state indicates the coding rate is missing. For example, the 3-state feedback may indicate (version 1): {Ack for PDSCH, Nack for PDSCH for any reason other than missing code rate, Nack for PDSCH due to missing code rate}, or (version 2): {Ack for PDSCH, Nack for PDSCH but with known code rate, Nack for PDSCH due to missing code rate or due to missing DCI}. The difference between the two versions above is whether missing DCI is treated as the second state or third state. Note that the event of interest here (missing code rate as the third state) is not due to missing a DCI 205 associated with a particular PDSCH 215, but due to missing a DCI 205 of an initial transmission of the PDSCH 215. In some cases, for a type-2 HARQ-ACK codebook with 3-state feedback, for a missing downlink assignment indicator (DAI) value, the UE 115-a may indicate the second state for version 1 and the third state for version 2. In other aspects, a 4-state (e.g., 2 bits) feedback may be provided per PDSCH 215, where the fourth state indicates the coding rate is missing, and the feedback may indicate: {Ack for PDSCH, Nack for PDSCH (but Ack for DCI) without missing code rate, Nack for DCI, NACK for PDSCH due to missing code rate (but Ack for DCI)}. In such cases, for a type-2 HARQ-ACK codebook, for a missing DAI value, the UE 115-a may indicate the 3rd state (and not the 4th state). Such a 3-state or 4-state feedback 220 may provide that discontinuous transmission (DTX) detection is not needed at the network entity 105-a for the case that feedback corresponds to a single PDSCH 215 or TB.

In some aspects, the feedback 220 may include an ACK/NACK indicator bit for each PDSCH 215 or TB, and an indication of a missing coding rate may be common to all PDSCHs 215 or TBs for which feedback is reported. Such an indication may be appended to, but separate from, the regular HARQ-ACK codebook (with regular 2-state ACK/NACK for each PDSCH/TB). The appended indication may indicate whether at least one scheduled PDSCH 215 has this issue and, if a missing coding rate is indicated, the network entity 105-a may use explicit MCS for all PDSCHs 215 that are NACKed, because it does not know which NACKed PDSCH 215 has the issue. In some cases, a single bit may be appended to the ACK/NACK bits that indicates whether at least one PDSCH 215 or TB has a missing code rate. In some cases, the bit may be set to 1 if at least one PDSCH 215 or TB has a missing code rate for which the scheduling DCI 205 is decoded, which may be referred to as version 3. In other cases, referred to as version 4, the bit may be set to 1 if at least one PDSCH 215 or TB has either has a missing code rate or if the scheduling DCI 205 is not decoded. If the UE 115-a indicates ACK for all PDSCHs 215 or TBs, the UE 115-a may set this bit to 0. In some cases, for a type-2 HARQ-ACK codebook, missing DAI value(s) are not considered in version 3 but they are considered in version 4.

In some cases, the feedback 220 may include two bits that are appended to the regular HARQ-ACK codebook (with regular 2-state ACK/NACK for each PDSCH/TB). In some examples, a first bit may indicate whether at least one PDSCH 215 or TB has a missing code rate but with a decoded scheduling DCI 205, and the second bit indicates whether a scheduling DCI 205 is missed for at least one PDSCH 215 or TB. If the UE 115-a indicates ACK for all PDSCHs 215 or TBs, the UE 115-a may set the two bits to “00” (assuming a value of 1 for each bit indicates a missing code rate or scheduling DCI 205, respectively). In such cases, for a type-2 HARQ-ACK codebook, if there is at least one missing DAI value, the second bit may be set to 1, but it has no impact on the first bit.

As discussed above, in some aspects a 3-state feedback indication may be used to indicate a missing coding rate for a PDSCH 215. In some cases, the three states may be {Ack for PDSCH, Nack for PDSCH (but Ack for DCI), Nack for DCI}. For a type-2 codebook, this means that this single bit (that is separate from the regular A/N feedback) is set to 1 if there is at least one missing DAI (one DAI hole based on the DAIs received in decoded DCIs), indicating that there is at least one missing DCI. For type-1 codebook, the bit may be set to 1 if there is at least one candidate PDSCH reception occasion that is not scheduled (e.g., the UE 115-a did not detect a DCI 205 scheduling a PDSCH 215 associated with a candidate reception occasion).

As discussed herein, in some cases resources for one or more PDSCHs 215 may be configured in an SPS configuration. In such communications, missed code rate may not occur because a TBS associated with the SPS transmissions is known based on an activation DCI that activates the SPS. SPS-PDSCH occasions are semi-static and periodic, and each transmission corresponds to initial transmission of a TB, and a PDSCH 215 that is scheduled by a DCI 205 with a CRC scrambled with CS-RNTI (i.e., a retransmission of SPS-PDSCH) will also have a TBS that is known based on the activation DCI. However, for type-2 codebook, a same number of states or bits is expected for PDSCHs scheduled by DCI with CRC scrambled by CS-RNTI (e.g., indicating SPS) versus C-RNTI (e.g., indicating dynamic scheduling). In some cases, when feedback 220 includes information for both SPS and dynamically scheduled PDSCH 215, only the PDSCHs 215 dynamically scheduled by DCI 205 are considered to be subject to the missing coding rate. In cases where 3-state or 4-state feedback is provided, this feedback is not applicable to SPS-PDSCHs, and one-bit feedback for SPS may be provided. In cases where a PDSCH 215 is scheduled by a DCI 205 with CRC scrambled with CS-RNTI (e.g., indicating a retransmission of a SPS-PDSCH), the associated feedback may have 3-states or 4-states, and the UE 115-a may not indicate missing code rate for these. In cases where 2-state feedback is provided and one or more bits are appended to the HARQ ACK/NACK bits the feedback 220, SPS-PDSCH(s) may not be considered for the indication provided by the appended bit(s). In addition, PDSCH 215 that is scheduled by a DCI 205 with CRC scrambled with CS-RNTI (e.g., indicating a retransmission of a SPS-PDSCH) are not considered.

In some cases, the network entity 105-a may provide configuration information to the UE 115-a that indicates whether the UE 115-a is to provide an indication of missing coding rates with HARQ-ACK feedback. In some cases, a network scheduler may not use reserved MCS for retransmissions, and in such cases the additional indication of a missing coding rate for one or more PDSCHs 215 is not needed, and the network entity 105-a may have flexibility to configure this functionality. In some cases, the configuration information may be provided by RRC signaling, a medium access control (MAC) control element (CE), or DCI. In cases where DCI provides such a configuration, a scheduling DCI 205 that schedules a PDSCH 215 with a given HARQ-ID and NDI may enable or disable this feature for the scheduled HARQ-ID dynamically. In some cases, the configuration can be per cell-group (e.g., for all component carriers (CCs) in the group), per CC, or per subset of HARQ-IDs in a CC. In this case, the network entity 105-a may either configure the subset of HARQ-IDs (e.g., a list of HARQ-IDs per CC) or can enable or disable this feature per HARQ-ID and per CC. Additionally, or alternatively, the UE 115-a can indicate whether it supports this feature by UE capability signaling.

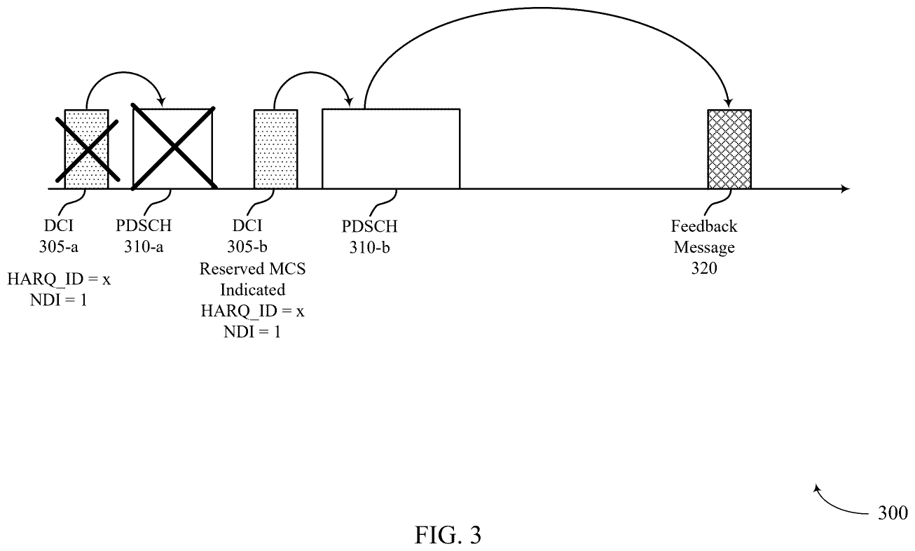

FIG. 3 shows an example of a timing diagram 300 that supports techniques for indicating missing coding rates in wireless communications in accordance with one or more aspects of the present disclosure. In some cases, the timing diagram 300 may implement or be implemented by aspects of the wireless communications system 100, wireless communications system 200, or both. For example, the timing diagram 300 may be implemented by one or more UEs 115 and one or more network entities 105, which may be examples of the corresponding devices as described herein.

As described herein, with reference to FIG. 2, a UE 115 may support providing indications of whether a coding rate is unknown for a PDSCH. For example, an initial DCI 305-a may be transmitted that provides a resource allocation and related parameters for an initial PDSCH 310-a, indicating a HARQ-ID (e.g., HARQ-ID=x) and having a NDI of 1, which may be a toggled NDI state relative to a prior NDI for HARQ-ID=x. However, in this example, the initial DCI 305-a may be missed (e.g., not successfully decoded from an associated control channel monitoring occasion). Continuing with this example, a second DCI 305-b may be transmitted by the network entity that includes an indication of a reserved MCS, HARQ-ID=x, and having an NDI of 1. The second DCI 305-b may schedule a second PDSCH 310-b, which may be a retransmitted instance of the initial PDSCH 310-a, and the second DCI 305-b may be successfully received at the UE (e.g., successfully decoded from an associated control channel monitoring occasion). The UE in such an example, may identify that the NDI for the associated HARQ-ID has been toggled from a prior NDI state associated with that HARQ-ID, which indicates an initial reception at the UE for the associated second PDSCH 310-b. However, the indication of a reserved MCS in the second DCI 305-b indicates to the UE that a prior DCI (e.g., the first DCI 305-a) included an explicit MCS for the associated HARQ-ID, and thus the UE may determine that the first DCI 305-a was not successfully received and that a coding rate (and therefore TBS) of the second PDSCH 310-b is unknown. The UE may transmit feedback message 320 in accordance with various aspects as discussed herein to indicate that the coding rate of the second PDSCH 310-b is unknown to the UE.

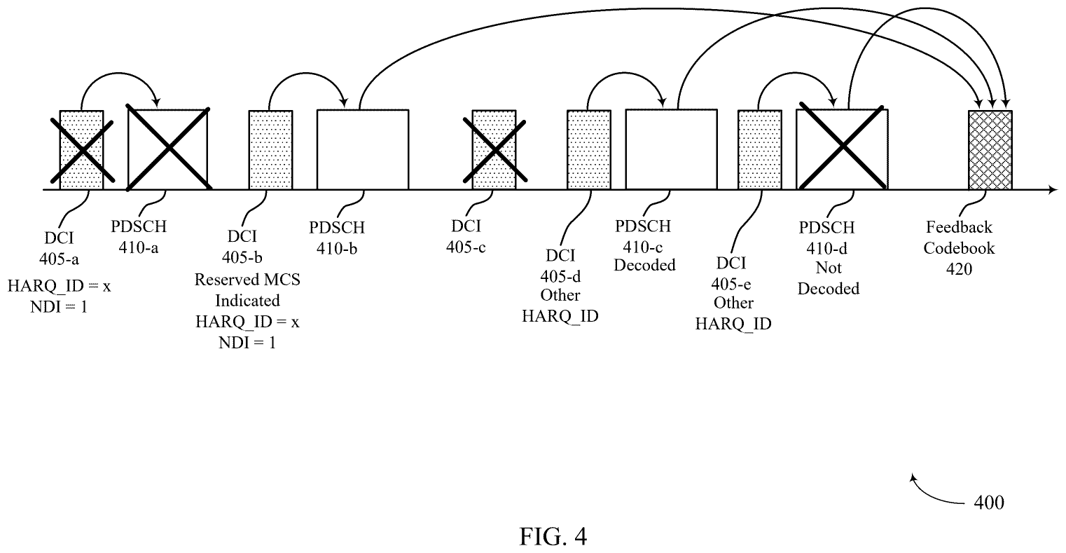

FIG. 4 shows another example of a timing diagram 400 that supports techniques for indicating missing coding rates in wireless communications in accordance with one or more aspects of the present disclosure. In some cases, the timing diagram 400 may implement or be implemented by aspects of the wireless communications system 100, wireless communications system 200, or both. For example, the timing diagram 400 may be implemented by one or more UEs 115 and one or more network entities 105, which may be examples of the corresponding devices as described herein.

As described herein, with reference to FIG. 2, a UE 115 may support providing indications of whether a coding rate is unknown for a PDSCH. In this example, an initial DCI 405-a may be transmitted that provides a resource allocation and related parameters for an initial PDSCH 410-a, indicating a HARQ-ID (e.g., HARQ-ID=x) and having a NDI of 1, which may be a toggled NDI state relative to a prior NDI for HARQ-ID=x. However, in this example, the initial DCI 405-a may be missed (e.g., not successfully decoded from an associated control channel monitoring occasion). Continuing with this example, a second DCI 405-b may be transmitted by the network entity that includes an indication of a reserved MCS, HARQ-ID=x, and having an NDI of 1. The second DCI 405-b may schedule a second PDSCH 410-b, which may be a retransmitted instance of the initial PDSCH 410-a, and the second DCI 405-b may be successfully received at the UE (e.g., successfully decoded from an associated control channel monitoring occasion). The UE in such an example, may identify that the NDI for the associated HARQ-ID has been toggled from a prior NDI state associated with that HARQ-ID, which indicates an initial reception at the UE for the associated second PDSCH 410-b. However, the indication of a reserved MCS in the second DCI 405-b indicates to the UE that a prior DCI (e.g., the first DCI 405-a) included an explicit MCS for the associated HARQ-ID, and thus the UE may determine that the first DCI 405-a was not successfully received and that a coding rate (and therefore TBS) of the second PDSCH 410-b is unknown.

Continuing with the example of FIG. 4, a third DCI 405-c may be transmitted, and not successfully decoded at the UE. A fourth DCI 405-d may schedule a third PDSCH 410-c, both of which may be successfully decoded at the UE, where the third PDSCH 410-c may be associated with a different HARQ-ID (not x). A fifth DCI 405-e may schedule a fourth PDSCH 410-d, where the fifth DCI 405-e may be decoded and the fourth PDSCH 410-d is not successfully decoded at the UE (also, the fourth PDSCH 410-d may be associated with a different HARQ-ID). In such an example, in accordance with various techniques as discussed herein, the UE may transmit a feedback codebook 420 associated with the DCIs 405 and PDSCHs 410. In cases where a 3-state feedback is provided in accordance with version 1 as discussed with reference to FIG. 2, the feedback codebook 420 may indicate {3rd feedback state, NACK, ACK, NACK}, corresponding to a NACK for the second PDSCH 410-b based on a missing code rate, NACK for any reason other than missing code rate for PDSCH associated with the third DCI 405-c, ACK for the third PDSCH 410-c, and NACK for any reason other than missing code rate for fourth PDSCH 410-d. In cases where a 3-state feedback is provided in accordance with version 2 as discussed with reference to FIG. 2, the feedback codebook 420 may indicate {3rd feedback state, 3rd feedback state, ACK, NACK} corresponding to a Nack for PDSCH due to missing code rate or due to missing DCI for the second PDSCH 410-b, Nack for PDSCH due to missing code rate or due to missing DCI for the PDSCH associated with the third DCI 405-c, ACK for the third PDSCH 410-c, and Nack for PDSCH but with known code rate for fourth PDSCH 410-d. In cases where a 4-state feedback is provided as discussed with reference to FIG. 2, the feedback codebook 420 may indicate {4th feedback state, 3rd feedback state, ACK, NACK} corresponding to a NACK for PDSCH due to missing code rate (but Ack for DCI) for the second PDSCH 410-b, Nack for DCI for the PDSCH associated with the third DCI 405-c, ACK for the third PDSCH 410-c, and Nack for PDSCH (but Ack for DCI) without missing code rate for fourth PDSCH 410-d. In cases where 2-state feedback with one appended bit is provided in accordance with version 3 as discussed with reference to FIG. 2, the feedback codebook 420 may indicate {NACK, NACK, ACK, NACK}+‘1’, corresponding to a NACK for PDSCH (for any reason) for the second PDSCH 410-b, Nack for DCI for the PDSCH associated with the third DCI 405-c, ACK for the third PDSCH 410-c, and NACK for PDSCH (for any reason) for fourth PDSCH 410-d, plus an additional bit set to ‘1’ due to at least one PDSCH 410 having a missing code rate. In cases where 2-state feedback is provided with one appended bit in accordance with version 4 as discussed with reference to FIG. 2, the feedback codebook 420 may indicate {NACK, NACK, ACK, NACK}+‘1’, corresponding to a NACK for PDSCH (for any reason) for the second PDSCH 410-b, Nack for DCI for the PDSCH associated with the third DCI 405-c, ACK for the third PDSCH 410-c, and NACK for PDSCH (for any reason) for fourth PDSCH 410-d, plus an additional bit set to ‘1’ due to at least one PDSCH 410 or TB has either having a missing code rate or the scheduling DCI 205 not decoded. In cases where 2-state feedback is provided with two appended bits as discussed with reference to FIG. 2, the feedback codebook 420 may indicate {NACK, NACK, ACK, NACK}+‘11’, corresponding to a NACK for PDSCH (for any reason) for the second PDSCH 410-b, Nack for DCI for the PDSCH associated with the third DCI 405-c, ACK for the third PDSCH 410-c, and NACK for PDSCH (for any reason) for fourth PDSCH 410-d, plus a first additional bit set to ‘1’ due to at least one PDSCH 410 having a missing code rate but with a decoded scheduling DCI 405, and a second additional feedback bit set to ‘1’ due to at least one PDSCH 410 having a missed scheduling DCI 405 for at least one PDSCH 215 or TB.

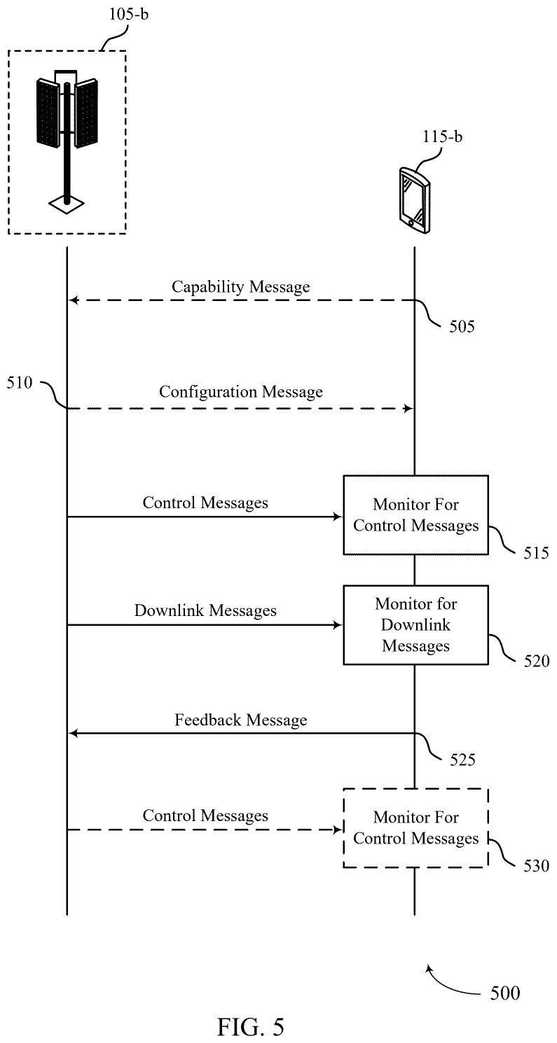

FIG. 5 shows an example of a process flow 500 that supports techniques for indicating missing coding rates in wireless communications in accordance with one or more aspects of the present disclosure. In some cases, the process flow 500 may implement or be implemented by aspects of the wireless communications system 100, the wireless communications system 200, the timing diagram 300, the timing diagram 400, or any combination thereof. For example, the process flow 500 may include one or more UEs 115 (e.g., a UE 115-b) and one or more network entities 105 (e.g., a network entity 105-b), which may be examples of the corresponding devices as described herein. In the following description of the process flow 500, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 500, and other operations may be added to the process flow 500.

In some cases, at 505, the UE 115-b may transmit, to the network entity 105-b, a capability message indicating a capability of the UE 115-b to support reporting of missing coding rates with feedback (e.g., HARQ feedback). In some cases, the capability indication may indicate whether the UE 115-b stores LLRs associated with PDSCHs or TBs when the associated coding rate, and thus TBS, is unknown at the UE 115-b.

In some cases, at 510, the network entity 105-b may transmit, and the UE 115-b may receive, a configuration message that may configure feedback information from the UE 115-b to include an indication of a missing coding rate for one or more PDSCHs or TBs.

At 515, the network entity 105-a may transmit, and the UE 115-b may monitor for, one or more control messages. The one or more control messages may include, for example, scheduling DCIs that provide scheduling information for one or more associated downlink messages (e.g., one or more PDSCHs or TBs). As discussed herein, in some cases the UE 115-b may miss one or more control messages that schedule an initial instance of a downlink message, and may successfully decode one or more subsequent control messages that schedule one or more retransmissions of the downlink message. In cases where a subsequent control message does not provide explicit information that may allow the UE 115-b to determine a TBS for the downlink message (e.g., when a scheduling DCI uses a reserved MCS), the UE 115-b may determine, as discussed herein, that an initial control message associated with the downlink message that includes the indication for determining TBS has been missed.

At 520, the network entity 105-b may transmit, and the UE 115-b may monitor for, one or more downlink messages. For example, the UE 115-b may monitor for one or more PDSCHs or TBs based on an associated control message. As discussed herein, in some cases the UE 115-b may not know an associated coding rate for the downlink message, and may store LLRs of the downlink message without attempting to decode the downlink message, where the stored LLRs may be soft-combined with one or more subsequent instances of the associated downlink message.

At 525, the UE 115-b may transmit, and the network entity 105-b may receive, a feedback message. The feedback message (e.g., a HARQ-ACK feedback message) may include an indication of whether one or more downlink messages are successfully received at the UE 115-b. In accordance with techniques discussed herein, the feedback message may also include an indication that a coding rate associated with one or more downlink messages is unknown the UE. Such an indication may be provided in accordance with various techniques as discussed herein.

In some cases, at 530, the network entity 105-b may transmit, and the UE 115-b may monitor for, one or more subsequent control messages. In some cases, the one or more subsequent control messages may provide an indication of a coding rate associated with one or more prior downlink messages for which the UE 115-b indicated that the coding rate was unknown.

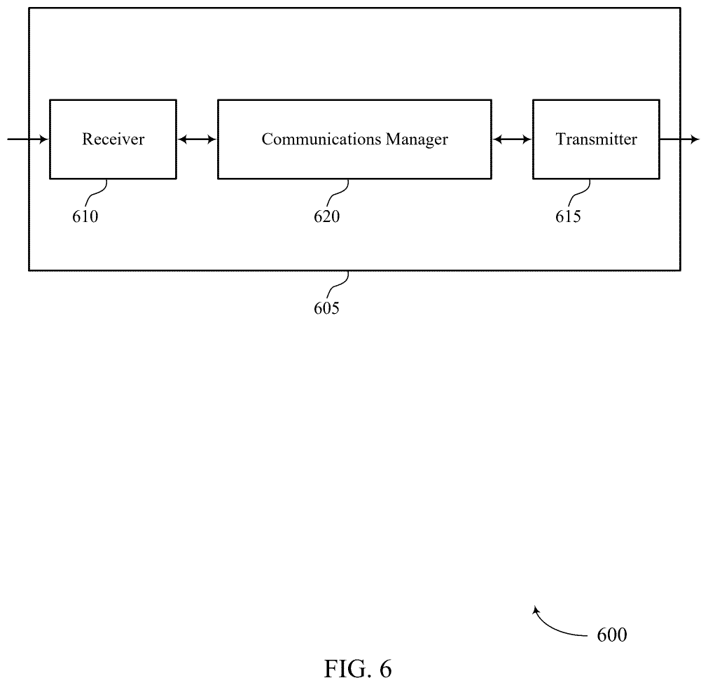

FIG. 6 shows a block diagram 600 of a device 605 that supports techniques for indicating missing coding rates in wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for indicating missing coding rates in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for indicating missing coding rates in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for indicating missing coding rates in wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a second control information message that indicates a set of wireless resources for a downlink transmission to the UE, where the second control information message indicates that a coding rate for the downlink transmission is provided in a first control information message. The communications manager 620 is capable of, configured to, or operable to support a means for transmitting a feedback message associated with the second control information message that includes an indication that the coding rate associated with the downlink transmission is unknown at the UE based on the first control information message being unsuccessfully received at the UE.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for indication of an unknown coding rate for one or more retransmitted communications, which may allow for providing such a coding rate in an efficient manner to reduce latency, reduce processing resource usage and power consumption, and provide for more efficient utilization of communication resources.

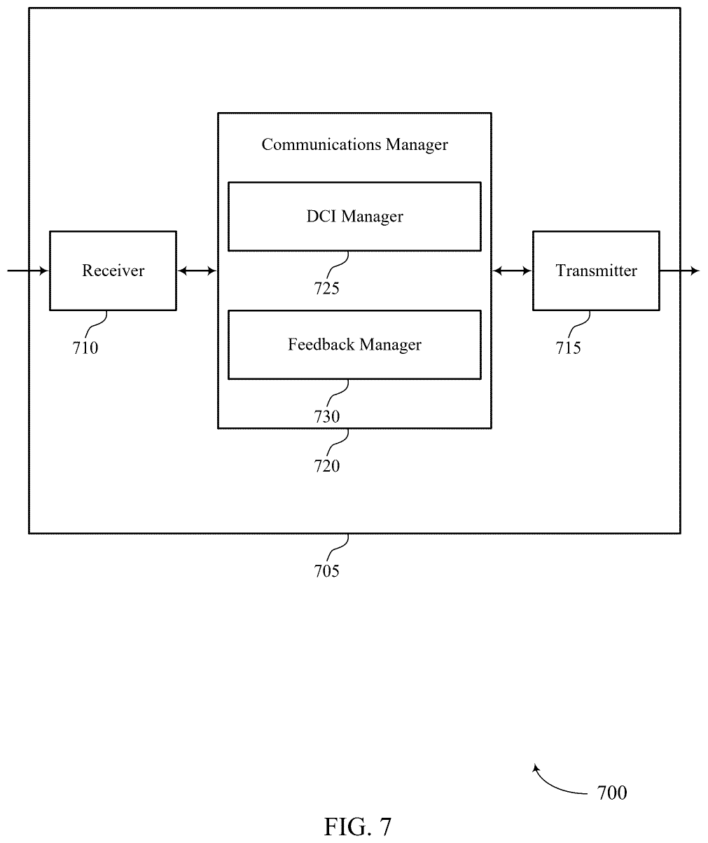

FIG. 7 shows a block diagram 700 of a device 705 that supports techniques for indicating missing coding rates in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for indicating missing coding rates in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for indicating missing coding rates in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for indicating missing coding rates in wireless communications as described herein. For example, the communications manager 720 may include a DCI manager 725 a feedback manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The DCI manager 725 is capable of, configured to, or operable to support a means for receiving a second control information message that indicates a set of wireless resources for a downlink transmission to the UE, where the second control information message indicates that a coding rate for the downlink transmission is provided in a first control information message. The feedback manager 730 is capable of, configured to, or operable to support a means for transmitting a feedback message associated with the second control information message that includes an indication that the coding rate associated with the downlink transmission is unknown at the UE based on the first control information message being unsuccessfully received at the UE.

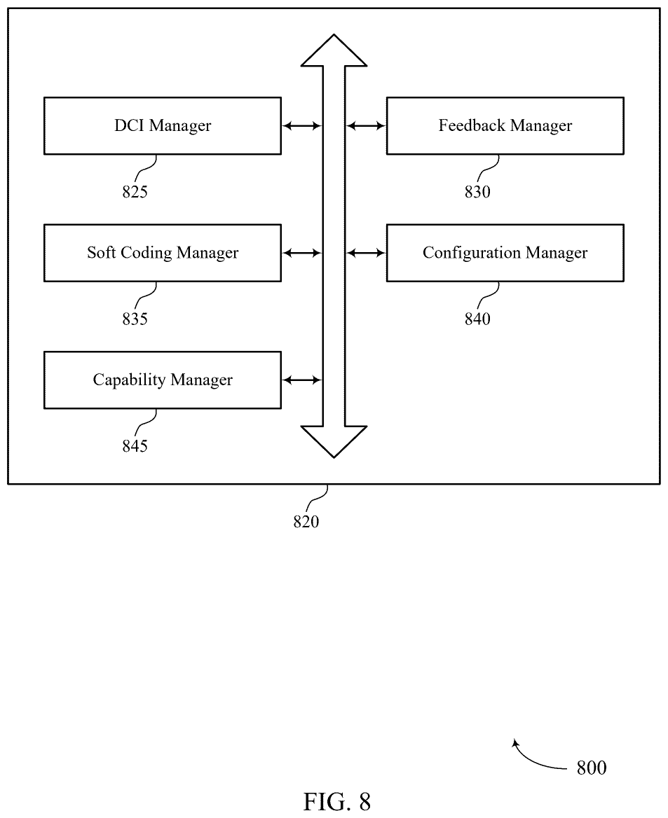

FIG. 8 shows a block diagram 800 of a communications manager 820 that supports techniques for indicating missing coding rates in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for indicating missing coding rates in wireless communications as described herein. For example, the communications manager 820 may include a DCI manager 825, a feedback manager 830, a soft coding manager 835, a configuration manager 840, a capability manager 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The DCI manager 825 is capable of, configured to, or operable to support a means for receiving a second control information message that indicates a set of wireless resources for a downlink transmission to the UE, where the second control information message indicates that a coding rate for the downlink transmission is provided in a first control information message. The feedback manager 830 is capable of, configured to, or operable to support a means for transmitting a feedback message associated with the second control information message that includes an indication that the coding rate associated with the downlink transmission is unknown at the UE based on the first control information message being unsuccessfully received at the UE.

In some examples, the DCI manager 825 is capable of, configured to, or operable to support a means for receiving, subsequent to transmitting the feedback message, a third control information message that indicates the coding rate for the downlink transmission. In some examples, the feedback message indicates that a transport block size associated with the downlink transmission is unknown at the UE. In some examples, the feedback message indicates that a reserved modulation and coding scheme is indicated for the downlink transmission, and that a new data indicator for a feedback identifier associated with the downlink transmission is toggled in the second control information message.

In some examples, the soft coding manager 835 is capable of, configured to, or operable to support a means for transmitting an indication of whether soft-coded bits associated with the downlink transmission are stored at the UE. In some examples, the indication of whether soft-coded bits associated with the downlink transmission are stored at the UE is provided with a capability indication provided by the UE, or is included with the feedback message associated with the second control information message.

In some examples, the UE indicates that soft-coded bits associated with a first instance of the downlink transmission are stored at the UE, and the soft coding manager 835 is capable of, configured to, or operable to support a means for receiving a second instance of the downlink transmission associated with a third control information message, where the third control information message indicates that the second instance of the downlink transmission has a different redundancy version than the first instance of the downlink transmission. In some examples, the UE indicates that soft-coded bits associated with a first instance of the downlink transmission are stored at the UE, and the soft coding manager 835 is capable of, configured to, or operable to support a means for combining the soft-coded bits associated with the first instance of the downlink transmission with soft-coded bits associated with the second instance of the downlink transmission. In some examples, the UE indicates that soft-coded bits associated with a first instance of the downlink transmission are stored at the UE, and the soft coding manager 835 is capable of, configured to, or operable to support a means for decoding the combined soft-coded bits to obtain information provided in the downlink transmission.

In some examples, the indication that the coding rate associated with the downlink transmission is unknown at the UE is included if the coding rate is unknown to the UE for at least one downlink transmission associated with the feedback message, and is provided in addition to a set of acknowledgment or negative-acknowledgment bits included in the feedback message. In some examples, the feedback message includes a single bit to indicate whether the coding rate associated with the at least one downlink transmission is known or unknown at the UE. In some examples, the feedback message includes two bits in addition to the set of acknowledgment or negative-acknowledgment bits, and where a first bit of the two bits indicates that the second control information message was successfully received and whether or not the coding rate associated with the at least one downlink transmission is unknown, and a second bit of the two bits indicates whether or not one or more control information messages have been received.

In some examples, the indication that the coding rate associated with the downlink transmission is unknown at the UE is provided separately for each of a set of multiple downlink transmissions associated with the feedback message. In some examples, the feedback message includes a three-state feedback indication associated with the downlink transmission, and where a third state of the three-state feedback indication indicates the coding rate associated with the downlink transmission is unknown at the UE. In some examples, the feedback message includes a four-state feedback indication associated with the downlink transmission, and where a third state indicates the second control information message was unsuccessfully received at the UE, and a fourth state of the four-state feedback indication indicates the coding rate associated with the downlink transmission is unknown at the UE. In some examples, the feedback message indicates whether the coding rate associated with one or more dynamically scheduled downlink transmissions is known or unknown at the UE, and the indication does not apply to one or more semi-persistently scheduled downlink transmissions associated with the feedback message.

In some examples, the configuration manager 840 is capable of, configured to, or operable to support a means for receiving configuration information that indicates whether the feedback message is to include the indication that the coding rate associated with the downlink transmission is unknown at the UE. In some examples, the configuration information is provided per cell-group for all carriers of each indicated cell group, per carrier, or per subset of feedback identifiers in a carrier.

In some examples, the capability manager 845 is capable of, configured to, or operable to support a means for transmitting capability signaling to a network entity that indicates the UE supports transmission of feedback messages that indicate whether the coding rate associated with one or more downlink transmissions is unknown at the UE.

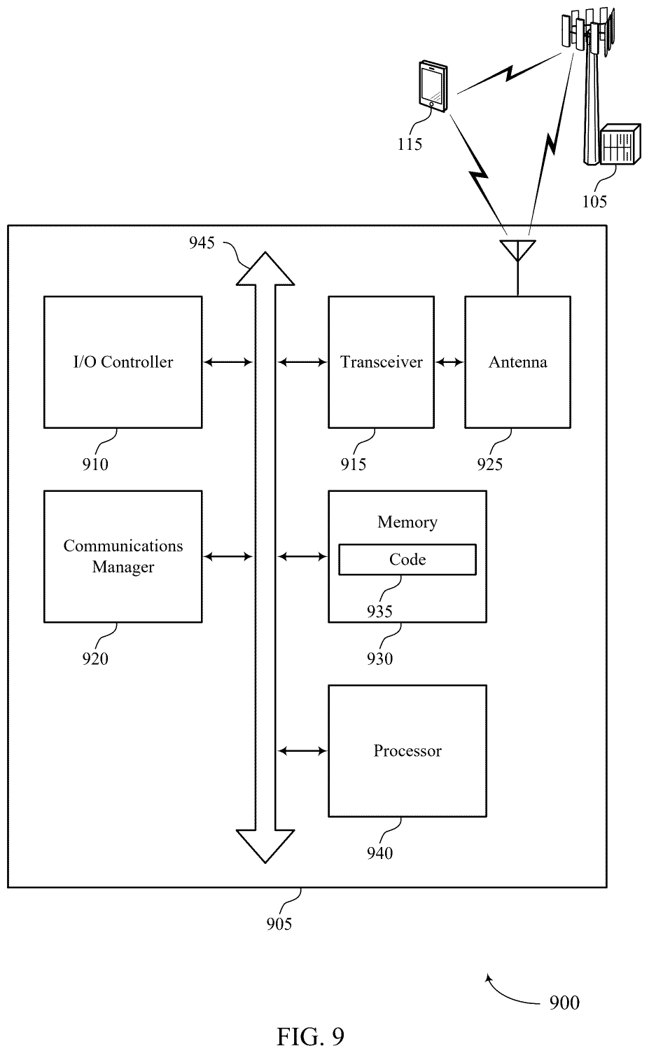

FIG. 9 shows a diagram of a system 900 including a device 905 that supports techniques for indicating missing coding rates in wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for indicating missing coding rates in wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a second control information message that indicates a set of wireless resources for a downlink transmission to the UE, where the second control information message indicates that a coding rate for the downlink transmission is provided in a first control information message. The communications manager 920 is capable of, configured to, or operable to support a means for transmitting a feedback message associated with the second control information message that includes an indication that the coding rate associated with the downlink transmission is unknown at the UE based on the first control information message being unsuccessfully received at the UE.

By including or configuring the communications manager 920 in accordance with examples as described herein, the device 905 may support techniques for indication of an unknown coding rate for one or more retransmitted communications, which may allow for providing such a coding rate in an efficient manner to reduce latency, reduce processing resource usage and power consumption, and provide for more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for indicating missing coding rates in wireless communications as described herein, or the at least one processor 940 and the at least one memory 930 may be otherwise configured to, individually or collectively, perform or support such operations.

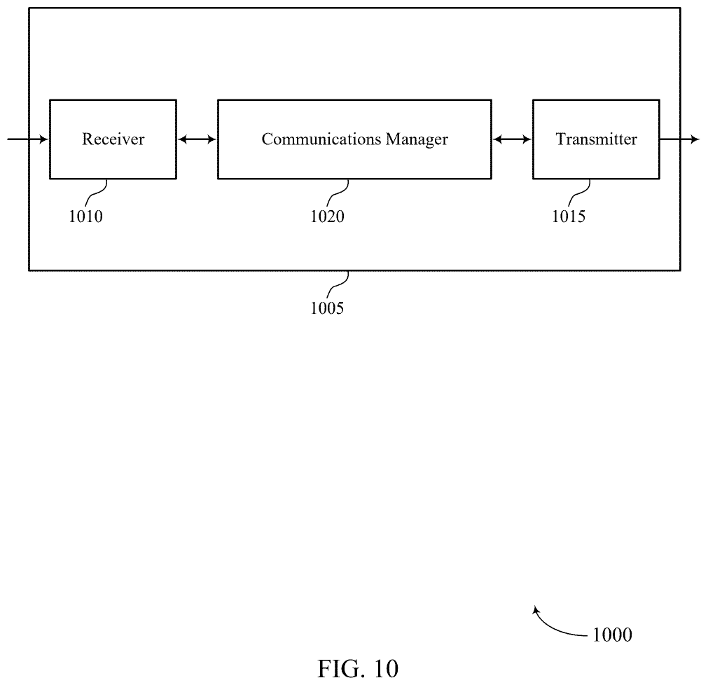

FIG. 10 shows a block diagram 1000 of a device 1005 that supports techniques for indicating missing coding rates in wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for indicating missing coding rates in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a first control information message that indicates a coding rate for a downlink transmission and a first set of wireless resources for a first instance of the downlink transmission to a UE. The communications manager 1020 is capable of, configured to, or operable to support a means for outputting the first instance of the downlink transmission. The communications manager 1020 is capable of, configured to, or operable to support a means for outputting a second control information message that indicates a second set of wireless resources for a second instance of the downlink transmission, where the second control information message indicates that the coding rate for the second instance of the downlink transmission is provided in the first control information message. The communications manager 1020 is capable of, configured to, or operable to support a means for outputting the second instance of the downlink transmission. The communications manager 1020 is capable of, configured to, or operable to support a means for obtaining, from the UE, a feedback message associated with the second control information message that includes an indication the coding rate associated with the downlink transmission is unknown at the UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for indication of an unknown coding rate for one or more retransmitted communications, which may allow for providing such a coding rate in an efficient manner to reduce latency, reduce processing resource usage and power consumption, and provide for more efficient utilization of communication resources.

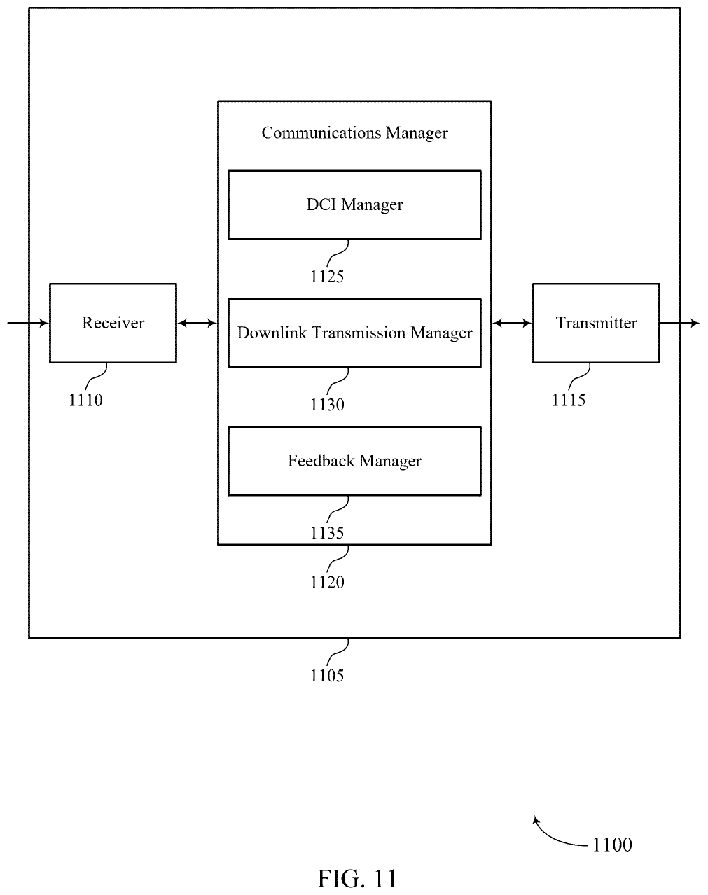

FIG. 11 shows a block diagram 1100 of a device 1105 that supports

techniques for indicating missing coding rates in wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for indicating missing coding rates in wireless communications as described herein. For example, the communications manager 1120 may include a DCI manager 1125, a downlink transmission manager 1130, a feedback manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The DCI manager 1125 is capable of, configured to, or operable to support a means for outputting a first control information message that indicates a coding rate for a downlink transmission and a first set of wireless resources for a first instance of the downlink transmission to a UE. The downlink transmission manager 1130 is capable of, configured to, or operable to support a means for outputting the first instance of the downlink transmission. The DCI manager 1125 is capable of, configured to, or operable to support a means for outputting a second control information message that indicates a second set of wireless resources for a second instance of the downlink transmission, where the second control information message indicates that the coding rate for the second instance of the downlink transmission is provided in the first control information message. The downlink transmission manager 1130 is capable of, configured to, or operable to support a means for outputting the second instance of the downlink transmission. The feedback manager 1135 is capable of, configured to, or operable to support a means for obtaining, from the UE, a feedback message associated with the second control information message that includes an indication the coding rate associated with the downlink transmission is unknown at the UE.

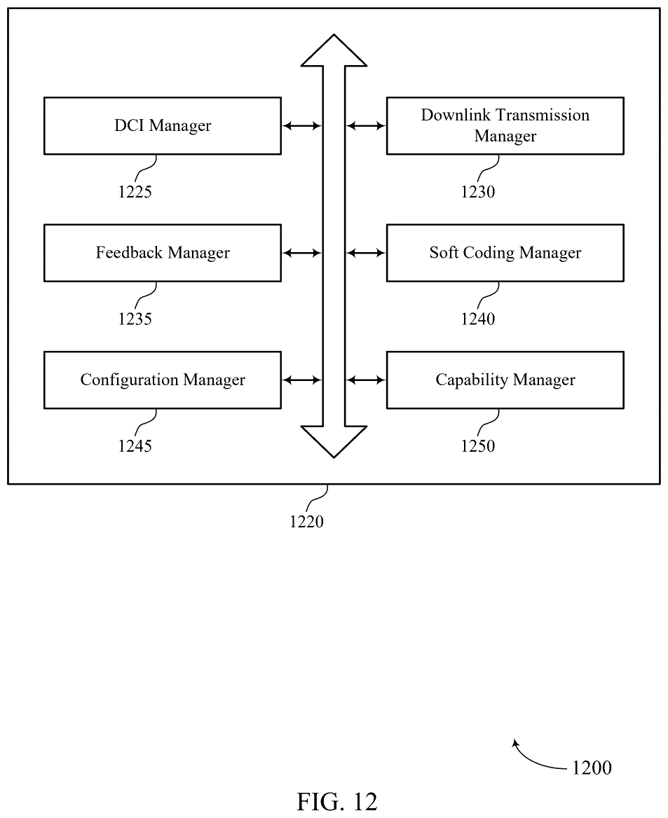

FIG. 12 shows a block diagram 1200 of a communications manager 1220 that supports techniques for indicating missing coding rates in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for indicating missing coding rates in wireless communications as described herein. For example, the communications manager 1220 may include a DCI manager 1225, a downlink transmission manager 1230, a feedback manager 1235, a soft coding manager 1240, a configuration manager 1245, a capability manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The DCI manager 1225 is capable of, configured to, or operable to support a means for outputting a first control information message that indicates a coding rate for a downlink transmission and a first set of wireless resources for a first instance of the downlink transmission to a UE. The downlink transmission manager 1230 is capable of, configured to, or operable to support a means for outputting the first instance of the downlink transmission. In some examples, the DCI manager 1225 is capable of, configured to, or operable to support a means for outputting a second control information message that indicates a second set of wireless resources for a second instance of the downlink transmission, where the second control information message indicates that the coding rate for the second instance of the downlink transmission is provided in the first control information message. In some examples, the downlink transmission manager 1230 is capable of, configured to, or operable to support a means for outputting the second instance of the downlink transmission. The feedback manager 1235 is capable of, configured to, or operable to support a means for obtaining, from the UE, a feedback message associated with the second control information message that includes an indication the coding rate associated with the downlink transmission is unknown at the UE.

In some examples, the DCI manager 1225 is capable of, configured to, or operable to support a means for outputting, subsequent to obtaining the feedback message, a third control information message that indicates the coding rate for the downlink transmission. In some examples, the feedback message indicates that a transport block size associated with the downlink transmission is unknown at the UE. In some examples, the feedback message indicates that a reserved modulation and coding scheme is indicated for the downlink transmission, and that a new data indicator for a feedback identifier associated with the downlink transmission is toggled in the second control information message.

In some examples, the soft coding manager 1240 is capable of, configured to, or operable to support a means for obtaining an indication of whether soft-coded bits associated with the downlink transmission are stored at the UE. In some examples, the indication of whether soft-coded bits associated with the downlink transmission are stored at the UE is provided with a capability indication provided by the UE, or is included with the feedback message associated with the second control information message.

In some examples, the downlink transmission manager 1230 is capable of, configured to, or operable to support a means for outputting a second instance of the downlink transmission associated with a third control information message, where the third control information message indicates that the second instance of the downlink transmission has a different redundancy version than the first instance of the downlink transmission.

In some examples, the indication that the coding rate associated with the downlink transmission is unknown at the UE is applied to at least one downlink transmission associated with the feedback message, and is provided in addition to a set of acknowledgment or negative-acknowledgment bits included in the feedback message. In some examples, the feedback message includes a single bit to indicate whether the coding rate associated with the at least one downlink transmission is known or unknown at the UE. In some examples, the feedback message includes two bits in addition to the set of acknowledgment or negative-acknowledgment bits, and where a first bit of the two bits indicates that the second control information message was successfully received and that the coding rate associated with the at least one downlink transmission is unknown, and a second bit of the two bits indicates whether or not one or more control information messages have been received. In some examples, the indication that the coding rate associated with the downlink transmission is unknown at the UE is provided separately for each of a set of multiple downlink transmissions associated with the feedback message.

In some examples, the feedback message includes a three-state feedback indication associated with the downlink transmission, and where a third state of the three-state feedback indication indicates the coding rate associated with the downlink transmission is unknown at the UE. In some examples, the feedback message includes a four-state feedback indication associated with the downlink transmission, and where a third state indicates the second control information message was unsuccessfully received at the UE, and a fourth state of the four-state feedback indication indicates the coding rate associated with the downlink transmission is unknown at the UE.

In some examples, the feedback message indicates whether the coding rate associated with one or more dynamically scheduled downlink transmissions is known or unknown at the UE, and the indication does not apply to one or more semi-persistently scheduled downlink transmissions associated with the feedback message.

In some examples, the configuration manager 1245 is capable of, configured to, or operable to support a means for outputting configuration information for the UE that indicates whether the feedback message is to include the indication that the coding rate associated with the downlink transmission is unknown at the UE. In some examples, the configuration information is provided per cell-group for all carriers of each indicated cell group, per carrier, or per subset of feedback identifiers in a carrier.

In some examples, the capability manager 1250 is capable of, configured to, or operable to support a means for obtaining capability signaling from the UE that indicates the UE supports transmission of feedback messages that indicate whether the coding rate associated with one or more downlink transmissions is unknown at the UE.

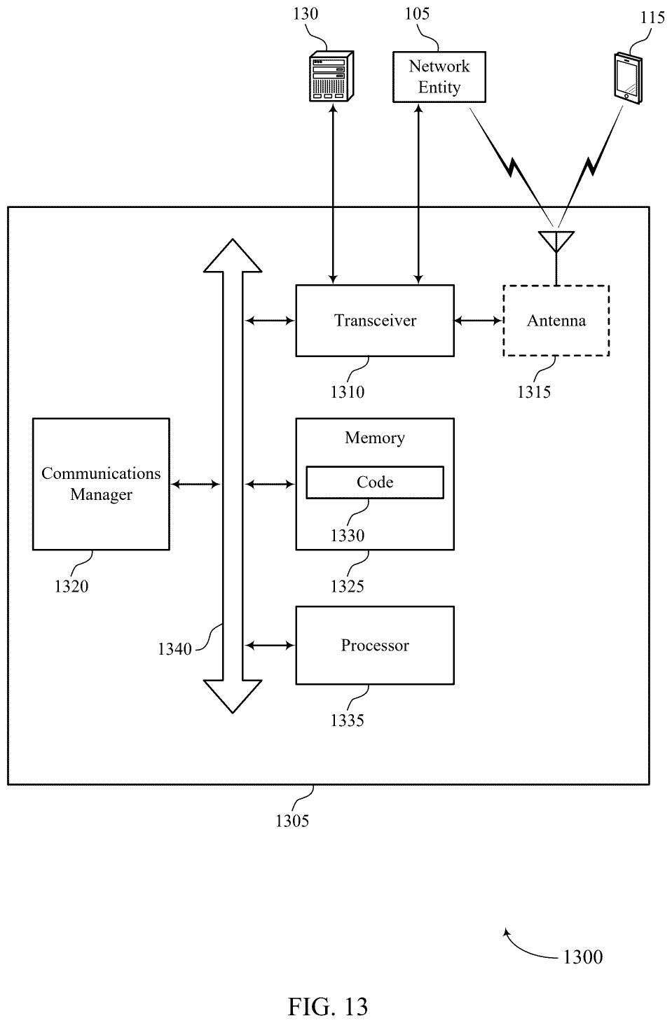

FIG. 13 shows a diagram of a system 1300 including a device 1305 that supports techniques for indicating missing coding rates in wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for indicating missing coding rates in wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a first control information message that indicates a coding rate for a downlink transmission and a first set of wireless resources for a first instance of the downlink transmission to a UE. The communications manager 1320 is capable of, configured to, or operable to support a means for outputting the first instance of the downlink transmission. The communications manager 1320 is capable of, configured to, or operable to support a means for outputting a second control information message that indicates a second set of wireless resources for a second instance of the downlink transmission, where the second control information message indicates that the coding rate for the second instance of the downlink transmission is provided in the first control information message. The communications manager 1320 is capable of, configured to, or operable to support a means for outputting the second instance of the downlink transmission. The communications manager 1320 is capable of, configured to, or operable to support a means for obtaining, from the UE, a feedback message associated with the second control information message that includes an indication the coding rate associated with the downlink transmission is unknown at the UE.

By including or configuring the communications manager 1320 in accordance with examples as described herein, the device 1305 may support techniques for indication of an unknown coding rate for one or more retransmitted communications, which may allow for providing such a coding rate in an efficient manner to reduce latency, reduce processing resource usage and power consumption, and provide for more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for indicating missing coding rates in wireless communications as described herein, or the at least one processor 1335 and the at least one memory 1325 may be otherwise configured to, individually or collectively, perform or support such operations.

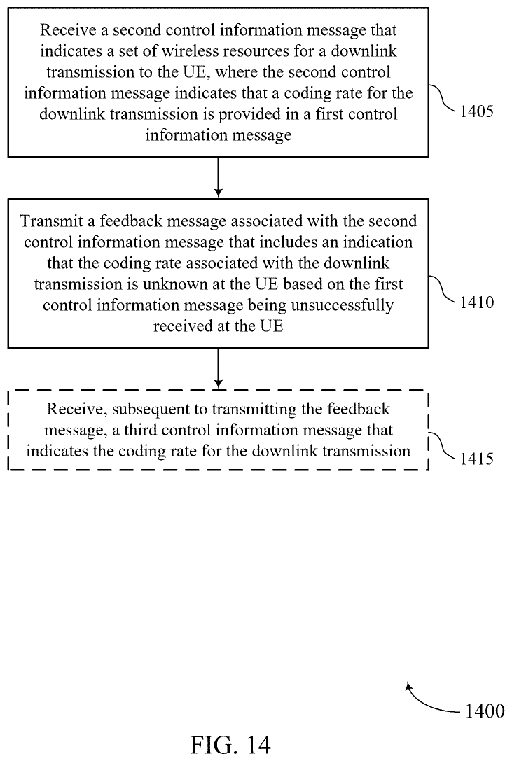

FIG. 14 shows a flowchart illustrating a method 1400 that supports techniques for indicating missing coding rates in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a second control information message that indicates a set of wireless resources for a downlink transmission to the UE, where the second control information message indicates that a coding rate for the downlink transmission is provided in a first control information message. The operations of 1405 may be performed in accordance with examples as disclosed herein. In some examples, aspects of the operations of 1405 may be performed by a DCI manager 825 as described with reference to FIG. 8.

At 1410, the method may include transmitting a feedback message associated with the second control information message that includes an indication that the coding rate associated with the downlink transmission is unknown at the UE based on the first control information message being unsuccessfully received at the UE. The operations of 1410 may be performed in accordance with examples as disclosed herein. In some examples, aspects of the operations of 1410 may be performed by a feedback manager 830 as described with reference to FIG. 8.

Optionally, at 1415, the method may include receiving, subsequent to transmitting the feedback message, a third control information message that indicates the coding rate for the downlink transmission. The operations of 1415 may be performed in accordance with examples as disclosed herein. In some examples, aspects of the operations of 1415 may be performed by a DCI manager 825 as described with reference to FIG. 8.

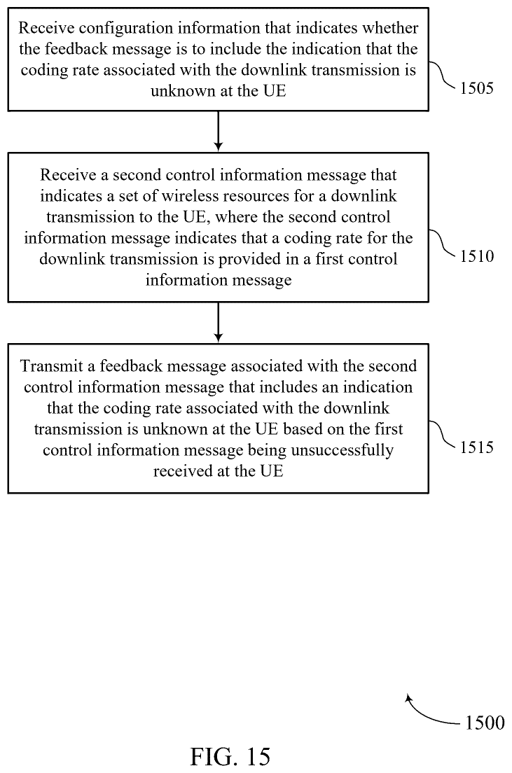

FIG. 15 shows a flowchart illustrating a method 1500 that supports techniques for indicating missing coding rates in wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving configuration information that indicates whether the feedback message is to include the indication that the coding rate associated with the downlink transmission is unknown at the UE. The operations of 1505 may be performed in accordance with examples as disclosed herein. In some examples, aspects of the operations of 1505 may be performed by a configuration manager 840 as described with reference to FIG. 8.

At 1510, the method may include receiving a second control information message that indicates a set of wireless resources for a downlink transmission to the UE, where the second control information message indicates that a coding rate for the downlink transmission is provided in a first control information message. The operations of 1510 may be performed in accordance with examples as disclosed herein. In some examples, aspects of the operations of 1510 may be performed by a DCI manager 825 as described with reference to FIG. 8.

At 1515, the method may include transmitting a feedback message associated with the second control information message that includes an indication that the coding rate associated with the downlink transmission is unknown at the UE based on the first control information message being unsuccessfully received at the UE. The operations of 1515 may be performed in accordance with examples as disclosed herein. In some examples, aspects of the operations of 1515 may be performed by a feedback manager 830 as described with reference to FIG. 8.

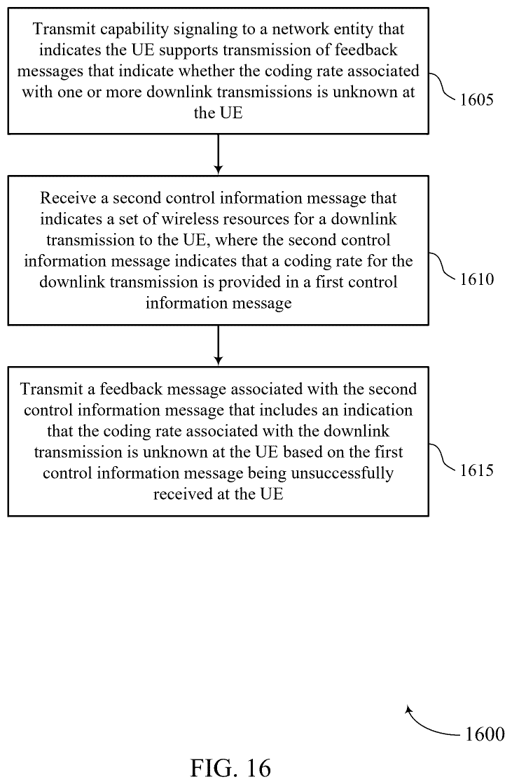

FIG. 16 shows a flowchart illustrating a method 1600 that supports techniques for indicating missing coding rates in wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting capability signaling to a network entity that indicates the UE supports transmission of feedback messages that indicate whether the coding rate associated with one or more downlink transmissions is unknown at the UE. The operations of 1605 may be performed in accordance with examples as disclosed herein. In some examples, aspects of the operations of 1605 may be performed by a capability manager 845 as described with reference to FIG. 8.

At 1610, the method may include receiving a second control information message that indicates a set of wireless resources for a downlink transmission to the UE, where the second control information message indicates that a coding rate for the downlink transmission is provided in a first control information message. The operations of 1610 may be performed in accordance with examples as disclosed herein. In some examples, aspects of the operations of 1610 may be performed by a DCI manager 825 as described with reference to FIG. 8.

At 1615, the method may include transmitting a feedback message associated with the second control information message that includes an indication that the coding rate associated with the downlink transmission is unknown at the UE based on the first control information message being unsuccessfully received at the UE. The operations of 1615 may be performed in accordance with examples as disclosed herein. In some examples, aspects of the operations of 1615 may be performed by a feedback manager 830 as described with reference to FIG. 8.

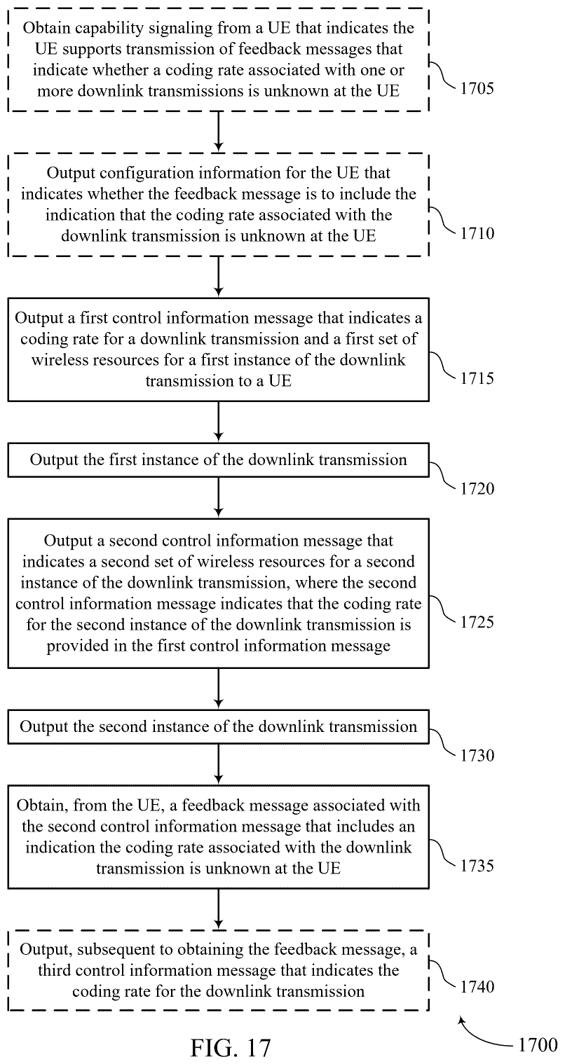

FIG. 17 shows a flowchart illustrating a method 1700 that supports techniques for indicating missing coding rates in wireless communications in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

Optionally, at 1705, the method may include obtaining capability signaling from the UE that indicates the UE supports transmission of feedback messages that indicate whether the coding rate associated with one or more downlink transmissions is unknown at the UE. The operations of 1705 may be performed in accordance with examples as disclosed herein. In some examples, aspects of the operations of 1705 may be performed by a capability manager 1250 as described with reference to FIG. 12.

Optionally, at 1710, the method may include outputting configuration information for the UE that indicates whether the feedback message is to include the indication that the coding rate associated with the downlink transmission is unknown at the UE. The operations of 1710 may be performed in accordance with examples as disclosed herein. In some examples, aspects of the operations of 1710 may be performed by a configuration manager 1245 as described with reference to FIG. 12.

At 1715, the method may include outputting a first control information message that indicates a coding rate for a downlink transmission and a first set of wireless resources for a first instance of the downlink transmission to a UE. The operations of 1715 may be performed in accordance with examples as disclosed herein. In some examples, aspects of the operations of 1715 may be performed by a DCI manager 1225 as described with reference to FIG. 12.

At 1720, the method may include outputting the first instance of the downlink transmission. The operations of 1720 may be performed in accordance with examples as disclosed herein. In some examples, aspects of the operations of 1720 may be performed by a downlink transmission manager 1230 as described with reference to FIG. 12.

At 1725, the method may include outputting a second control information message that indicates a second set of wireless resources for a second instance of the downlink transmission, where the second control information message indicates that the coding rate for the second instance of the downlink transmission is provided in the first control information message. The operations of 1725 may be performed in accordance with examples as disclosed herein. In some examples, aspects of the operations of 1725 may be performed by a DCI manager 1225 as described with reference to FIG. 12.

At 1730, the method may include outputting the second instance of the downlink transmission. The operations of 1730 may be performed in accordance with examples as disclosed herein. In some examples, aspects of the operations of 1730 may be performed by a downlink transmission manager 1230 as described with reference to FIG. 12.

At 1735, the method may include obtaining, from the UE, a feedback message associated with the second control information message that includes an indication the coding rate associated with the downlink transmission is unknown at the UE. The operations of 1735 may be performed in accordance with examples as disclosed herein. In some examples, aspects of the operations of 1735 may be performed by a feedback manager 1235 as described with reference to FIG. 12.

Optionally, at 1740, the method may include outputting, subsequent to obtaining the feedback message, a third control information message that indicates the coding rate for the downlink transmission. The operations of 1740 may be performed in accordance with examples as disclosed herein. In some examples, aspects of the operations of 1740 may be performed by a DCI manager 1225 as described with reference to FIG. 12.

The following provides an overview of aspects of the present disclosure:

Aspect 1: A method for wireless communications at a UE, comprising: receiving a second control information message that indicates a set of wireless resources for a downlink transmission to the UE, wherein the second control information message indicates that a coding rate for the downlink transmission is provided in a first control information message; and transmitting a feedback message associated with the second control information message that includes an indication that the coding rate associated with the downlink transmission is unknown at the UE based at least in part on the first control information message being unsuccessfully received at the UE.

Aspect 2: The method of aspect 1, further comprising: receiving, subsequent to transmitting the feedback message, a third control information message that indicates the coding rate for the downlink transmission.

Aspect 3: The method of any of aspects 1 through 2, wherein the feedback message indicates that a transport block size associated with the downlink transmission is unknown at the UE.

Aspect 4: The method of any of aspects 1 through 3, wherein the feedback message indicates that a reserved modulation and coding scheme is indicated for the downlink transmission, and that a new data indicator for a feedback identifier associated with the downlink transmission is toggled in the second control information message.

Aspect 5: The method of any of aspects 1 through 4, further comprising: transmitting an indication of whether soft-coded bits associated with the downlink transmission are stored at the UE.

Aspect 6: The method of aspect 5, wherein the indication of whether soft-coded bits associated with the downlink transmission are stored at the UE is provided with a capability indication provided by the UE, or is included with the feedback message associated with the second control information message.

Aspect 7: The method of any of aspects 5 through 6, wherein the UE indicates that soft-coded bits associated with a first instance of the downlink transmission are stored at the UE, and wherein the method further comprises: receiving a second instance of the downlink transmission associated with a third control information message, wherein the third control information message indicates that the second instance of the downlink transmission has a different redundancy version than the first instance of the downlink transmission; combining the soft-coded bits associated with the first instance of the downlink transmission with soft-coded bits associated with the second instance of the downlink transmission; and decoding the combined soft-coded bits to obtain information provided in the downlink transmission.

Aspect 8: The method of any of aspects 1 through 7, wherein the indication that the coding rate associated with the downlink transmission is unknown at the UE is included if the coding rate is unknown to the UE for at least one downlink transmission associated with the feedback message, and is provided in addition to a set of acknowledgment or negative-acknowledgment bits included in the feedback message.

Aspect 9: The method of aspect 8, wherein the feedback message includes a single bit to indicate whether the coding rate associated with the at least one downlink transmission is known or unknown at the UE.

Aspect 10: The method of aspect 8, wherein the feedback message includes two bits in addition to the set of acknowledgment or negative-acknowledgment bits, and wherein a first bit of the two bits indicates that the second control information message was successfully received and whether or not the coding rate associated with the at least one downlink transmission is unknown, and a second bit of the two bits indicates whether or not one or more control information messages have been received.

Aspect 11: The method of any of aspects 1 through 7, wherein the indication that the coding rate associated with the downlink transmission is unknown at the UE is provided separately for each of a plurality of downlink transmissions associated with the feedback message.

Aspect 12: The method of any of aspects 1 through 7, wherein the feedback message includes a three-state feedback indication associated with the downlink transmission, and wherein a third state of the three-state feedback indication indicates the coding rate associated with the downlink transmission is unknown at the UE.

Aspect 13: The method of any of aspects 1 through 7, wherein the feedback message includes a four-state feedback indication associated with the downlink transmission, and wherein a third state indicates the second control information message was unsuccessfully received at the UE, and a fourth state of the four-state feedback indication indicates the coding rate associated with the downlink transmission is unknown at the UE.

Aspect 14: The method of any of aspects 1 through 13, wherein the feedback message indicates whether the coding rate associated with one or more dynamically scheduled downlink transmissions is known or unknown at the UE, and the indication does not apply to one or more semi-persistently scheduled downlink transmissions associated with the feedback message.

Aspect 15: The method of any of aspects 1 through 14, further comprising: receiving configuration information that indicates whether the feedback message is to include the indication that the coding rate associated with the downlink transmission is unknown at the UE.

Aspect 16: The method of aspect 15, wherein the configuration information is provided per cell-group for all carriers of each indicated cell group, per carrier, or per subset of feedback identifiers in a carrier.

Aspect 17: The method of any of aspects 1 through 16, further comprising: transmitting capability signaling to a network entity that indicates the UE supports transmission of feedback messages that indicate whether the coding rate associated with one or more downlink transmissions is unknown at the UE.

Aspect 18: A method for wireless communications at a network entity, comprising: outputting a first control information message that indicates a coding rate for a downlink transmission and a first set of wireless resources for a first instance of the downlink transmission to a UE; outputting the first instance of the downlink transmission; outputting a second control information message that indicates a second set of wireless resources for a second instance of the downlink transmission, wherein the second control information message indicates that the coding rate for the second instance of the downlink transmission is provided in the first control information message; outputting the second instance of the downlink transmission; and obtaining, from the UE, a feedback message associated with the second control information message that includes an indication the coding rate associated with the downlink transmission is unknown at the UE.

Aspect 19: The method of aspect 18, further comprising: outputting, subsequent to obtaining the feedback message, a third control information message that indicates the coding rate for the downlink transmission.

Aspect 20: The method of any of aspects 18 through 19, wherein the feedback message indicates that a transport block size associated with the downlink transmission is unknown at the UE.

Aspect 21: The method of any of aspects 18 through 20, wherein the feedback message indicates that a reserved modulation and coding scheme is indicated for the downlink transmission, and that a new data indicator for a feedback identifier associated with the downlink transmission is toggled in the second control information message.

Aspect 22: The method of any of aspects 18 through 21, further comprising: obtaining an indication of whether soft-coded bits associated with the downlink transmission are stored at the UE.

Aspect 23: The method of aspect 22, wherein the indication of whether soft-coded bits associated with the downlink transmission are stored at the UE is provided with a capability indication provided by the UE, or is included with the feedback message associated with the second control information message.

Aspect 24: The method of any of aspects 22 through 23, further comprising: outputting a second instance of the downlink transmission associated with a third control information message, wherein the third control information message indicates that the second instance of the downlink transmission has a different redundancy version than the first instance of the downlink transmission.

Aspect 25: The method of any of aspects 18 through 24, wherein the indication that the coding rate associated with the downlink transmission is unknown at the UE is applied to at least one downlink transmission associated with the feedback message, and is provided in addition to a set of acknowledgment or negative-acknowledgment bits included in the feedback message.

Aspect 26: The method of aspect 25, wherein the feedback message includes a single bit to indicate whether the coding rate associated with the at least one downlink transmission is known or unknown at the UE.

Aspect 27: The method of aspect 25, wherein the feedback message includes two bits in addition to the set of acknowledgment or negative-acknowledgment bits, and wherein a first bit of the two bits indicates that the second control information message was successfully received and that the coding rate associated with the at least one downlink transmission is unknown, and a second bit of the two bits indicates whether or not one or more control information messages have been received.

Aspect 28: The method of any of aspects 18 through 25, wherein the indication that the coding rate associated with the downlink transmission is unknown at the UE is provided separately for each of a plurality of downlink transmissions associated with the feedback message.

Aspect 29: The method of any of aspects 18 through 25, wherein the feedback message includes a three-state feedback indication associated with the downlink transmission, and wherein a third state of the three-state feedback indication indicates the coding rate associated with the downlink transmission is unknown at the UE.

Aspect 30: The method of any of aspects 18 through 25, wherein the feedback message includes a four-state feedback indication associated with the downlink transmission, and wherein a third state indicates the second control information message was unsuccessfully received at the UE, and a fourth state of the four-state feedback indication indicates the coding rate associated with the downlink transmission is unknown at the UE.

Aspect 31: The method of any of aspects 18 through 30, wherein the feedback message indicates whether the coding rate associated with one or more dynamically scheduled downlink transmissions is known or unknown at the UE, and the indication does not apply to one or more semi-persistently scheduled downlink transmissions associated with the feedback message.

Aspect 32: The method of any of aspects 18 through 31, further comprising: outputting configuration information for the UE that indicates whether the feedback message is to include the indication that the coding rate associated with the downlink transmission is unknown at the UE.

Aspect 33: The method of aspect 32, wherein the configuration information is provided per cell-group for all carriers of each indicated cell group, per carrier, or per subset of feedback identifiers in a carrier.

Aspect 34: The method of any of aspects 18 through 33, further comprising: obtaining capability signaling from the UE that indicates the UE supports transmission of feedback messages that indicate whether the coding rate associated with one or more downlink transmissions is unknown at the UE.

Aspect 35: A UE for wireless communications, comprising one or more memories storing processor-executable code, and one or more processors coupled with the one or more memories and individually or collectively operable to execute the code to cause the UE to perform a method of any of aspects 1 through 17.

Aspect 36: A UE for wireless communications, comprising at least one means for performing a method of any of aspects 1 through 17.

Aspect 37: A non-transitory computer-readable medium storing code for wireless communications, the code comprising instructions executable by one or more processors to perform a method of any of aspects 1 through 17.

Aspect 38: A network entity for wireless communications, comprising one or more memories storing processor-executable code, and one or more processors coupled with the one or more memories and individually or collectively operable to execute the code to cause the network entity to perform a method of any of aspects 18 through 34.

Aspect 39: A network entity for wireless communications, comprising at least one means for performing a method of any of aspects 18 through 34.

Aspect 40: A non-transitory computer-readable medium storing code for wireless communications, the code comprising instructions executable by one or more processors to perform a method of any of aspects 18 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a second control information message that indicates a set of wireless resources for a downlink transmission to the UE, wherein the second control information message indicates that a coding rate for the downlink transmission is provided in a first control information message; and
transmit a feedback message associated with the second control information message that includes an indication that the coding rate associated with the downlink transmission is unknown at the UE based at least in part on the first control information message being unsuccessfully received at the UE.

2. The UE of claim 1, wherein the one or more processors are individually or collectively further operable to execute the code to cause the UE to:
receive, subsequent to transmitting the feedback message, a third control information message that indicates the coding rate for the downlink transmission.

3. The UE of claim 1, wherein the feedback message indicates that a transport block size associated with the downlink transmission is unknown at the UE.

4. The UE of claim 1, wherein the feedback message indicates that a reserved modulation and coding scheme is indicated for the downlink transmission, and that a new data indicator for a feedback identifier associated with the downlink transmission is toggled in the second control information message.

5. The UE of claim 1, wherein the one or more processors are individually or collectively further operable to execute the code to cause the UE to:
transmit an indication of whether soft-coded bits associated with the downlink transmission are stored at the UE.

6. The UE of claim 5, wherein the indication of whether soft-coded bits associated with the downlink transmission are stored at the UE is provided with a capability indication provided by the UE, or is included with the feedback message associated with the second control information message.

7. The UE of claim 5, wherein the UE indicates that soft-coded bits associated with a first instance of the downlink transmission are stored at the UE, and the one or more processors are individually or collectively further operable to execute the code to cause the UE to:
receive a second instance of the downlink transmission associated with a third control information message, wherein the third control information message indicates that the second instance of the downlink transmission has a different redundancy version than the first instance of the downlink transmission;
combine the soft-coded bits associated with the first instance of the downlink transmission with soft-coded bits associated with the second instance of the downlink transmission; and
decode the combined soft-coded bits to obtain information provided in the downlink transmission.

8. The UE of claim 1, wherein the indication that the coding rate associated with the downlink transmission is unknown at the UE is included if the coding rate is unknown to the UE for at least one downlink transmission associated with the feedback message, and is provided in addition to a set of acknowledgment or negative-acknowledgment bits included in the feedback message.

9. The UE of claim 8, wherein the feedback message includes a single bit to indicate whether the coding rate associated with the at least one downlink transmission is known or unknown at the UE.

10. The UE of claim 8, wherein the feedback message includes two bits in addition to the set of acknowledgment or negative-acknowledgment bits, and wherein a first bit of the two bits indicates that the second control information message was successfully received and whether or not the coding rate associated with the at least one downlink transmission is unknown, and a second bit of the two bits indicates whether or not one or more control information messages have been received.

11. The UE of claim 1, wherein the indication that the coding rate associated with the downlink transmission is unknown at the UE is provided separately for each of a plurality of downlink transmissions associated with the feedback message.

12. The UE of claim 1, wherein the feedback message includes a three-state feedback indication associated with the downlink transmission, and wherein a third state of the three-state feedback indication indicates the coding rate associated with the downlink transmission is unknown at the UE.

13. The UE of claim 1, wherein the feedback message includes a four-state feedback indication associated with the downlink transmission, and wherein a third state indicates the second control information message was unsuccessfully received at the UE, and a fourth state of the four-state feedback indication indicates the coding rate associated with the downlink transmission is unknown at the UE.

14. The UE of claim 1, wherein the feedback message indicates whether the coding rate associated with one or more dynamically scheduled downlink transmissions is known or unknown at the UE, and the indication does not apply to one or more semi-persistently scheduled downlink transmissions associated with the feedback message.

15. The UE of claim 1, wherein the one or more processors are individually or collectively further operable to execute the code to cause the UE to:
receive configuration information that indicates whether the feedback message is to include the indication that the coding rate associated with the downlink transmission is unknown at the UE.

16. The UE of claim 15, wherein the configuration information is provided per cell-group for all carriers of each indicated cell group, per carrier, or per subset of feedback identifiers in a carrier.

17. The UE of claim 1, wherein the one or more processors are individually or collectively further operable to execute the code to cause the UE to:
transmit capability signaling to a network entity that indicates the UE supports transmission of feedback messages that indicate whether the coding rate associated with one or more downlink transmissions is unknown at the UE.

18. A network entity, comprising:
one or more memories storing processor-executable code; and
one or more processors coupled with the one or more memories and individually or collectively operable to execute the code to cause the network entity to:
output a first control information message that indicates a coding rate for a downlink transmission and a first set of wireless resources for a first instance of the downlink transmission to a user equipment (UE);
output the first instance of the downlink transmission;
output a second control information message that indicates a second set of wireless resources for a second instance of the downlink transmission, wherein the second control information message indicates that the coding rate for the second instance of the downlink transmission is provided in the first control information message;
output the second instance of the downlink transmission; and
obtain, from the UE, a feedback message associated with the second control information message that includes an indication the coding rate associated with the downlink transmission is unknown at the UE.

19. The network entity of claim 18, wherein the feedback message indicates that a transport block size associated with the downlink transmission is unknown at the UE.

20. The network entity of claim 18, wherein the one or more processors are individually or collectively further operable to execute the code to cause the network entity to:
obtain an indication of whether soft-coded bits associated with the downlink transmission are stored at the UE.

21. The network entity of claim 18, wherein the indication that the coding rate associated with the downlink transmission is unknown at the UE is applied to at least one downlink transmission associated with the feedback message, and is provided in addition to a set of acknowledgment or negative-acknowledgment bits included in the feedback message.

22. The network entity of claim 18, wherein the feedback message includes a three-state feedback indication associated with the downlink transmission, and wherein a third state of the three-state feedback indication indicates the coding rate associated with the downlink transmission is unknown at the UE.

23. A method for wireless communications at a user equipment (UE), comprising:
receiving a second control information message that indicates a set of wireless resources for a downlink transmission to the UE, wherein the second control information message indicates that a coding rate for the downlink transmission is provided in a first control information message; and
transmitting a feedback message associated with the second control information message that includes an indication that the coding rate associated with the downlink transmission is unknown at the UE based at least in part on the first control information message being unsuccessfully received at the UE.

24. The method of claim 23, further comprising:
transmitting an indication of whether soft-coded bits associated with the downlink transmission are stored at the UE.

25. The method of claim 23, wherein the indication that the coding rate associated with the downlink transmission is unknown at the UE is included if the coding rate is unknown to the UE for at least one downlink transmission associated with the feedback message, and is provided in addition to a set of acknowledgment or negative-acknowledgment bits included in the feedback message.

26. The method of claim 23, wherein the indication that the coding rate associated with the downlink transmission is unknown at the UE is provided separately for each of a plurality of downlink transmissions associated with the feedback message.

27. The method of claim 23, wherein the feedback message includes a three-state feedback indication associated with the downlink transmission, and wherein a third state of the three-state feedback indication indicates the coding rate associated with the downlink transmission is unknown at the UE.

28. A method for wireless communications at a network entity, comprising:
outputting a first control information message that indicates a coding rate for a downlink transmission and a first set of wireless resources for a first instance of the downlink transmission to a user equipment (UE);
outputting the first instance of the downlink transmission;
outputting a second control information message that indicates a second set of wireless resources for a second instance of the downlink transmission, wherein the second control information message indicates that the coding rate for the second instance of the downlink transmission is provided in the first control information message;
outputting the second instance of the downlink transmission; and
obtaining, from the UE, a feedback message associated with the second control information message that includes an indication the coding rate associated with the downlink transmission is unknown at the UE.

29. The method of claim 28, further comprising:
obtaining an indication of whether soft-coded bits associated with the downlink transmission are stored at the UE.

30. The method of claim 28, wherein the indication that the coding rate associated with the downlink transmission is unknown at the UE is applied to at least one downlink transmission associated with the feedback message, and is provided in addition to a set of acknowledgment or negative-acknowledgment bits included in the feedback message.
